(19) United States
(12) Patent Application Publication
(10) Pub. No.: US 2008/0311857 A1
(43) Pub. Date: Dec. 18, 2008

(54) Receiver, transmitter, communication system, method for controlling receiver, and communication method

(75) Inventors: Hitoshi Naoe, Kitakatsuragi-gun (JP); Fumihiro Fukae, Sakurai-shi (JP); Koji Sakai, Osaka-shi (JP)

Correspondence Address: BIRCH STEWART KOLASCH & BIRCH, PO BOX 747, FALLS CHURCH, VA, 22040-0747, US

(73) Assignee: SHARP KABUSHIKI KAISHA

(21) Appl. No.: 12/155,999

(22) Filed: Jun. 12, 2008

(30) Foreign Application Priority Data
Jun. 14, 2007 (JP) 2007-158021

(51) Int. Cl. H04B 1/00

(52) U.S. Cl. 455/68

(57) ABSTRACT

A receiver establishes a communication between the receiver and a transmitter that transmits data by a directional wireless communication. While a connection request command which is information for requesting a connection is transmitted from the transmitter to the receiver at a predetermined period, a packet group corresponding to the connection request command is transmitted from the transmitter to the receiver. The receiver includes a receiver connection establishment control section which controls a communication device so that a connection between the transmitter and the receiver is established in accordance with the connection request command, in a case where the connection request information is received from the transmitter while the communication with the transmitter and the receiver is released. This allows the receiver to naturally reproduce streaming data with the use of a directional wireless communication.

This Nonprovisional application claims priority under 35 U.S.C. §119(a) on Patent Application No. 158021/2007 filed in Japan on Jun. 14, 2007, the entire contents of which are hereby incorporated by reference.

### FIELD OF THE INVENTION

The present invention relates to a receiver which establishes, by a directional wireless communication, a communication between the receiver and a transmitter that transmits data, and which receives the data transmitted from the transmitter, a transmitter, a communication system, a method for controlling a receiver, and a communication method.

### BACKGROUND OF THE INVENTION

Recently, multimedia data such as video data or audio data are available in various ways, for example, in a way in which multimedia data is stored in a medium such as CD or DVD and is reproduced from the medium by a reproducing device, or in a way in which multimedia data is supplied via a network and is reproduced by a reproducing device.

According to the latter way, one of the following two systems is used, for example. In one of the two systems (storage type), multimedia data are transferred at a time from a source such as a server to a reproducing device via a network. The reproducing device causes (i) the transferred multimedia data to be stored in a storage device, and (ii) the stored data to be read out and reproduced from the storage device. In the other of the two systems (streaming type), divided multimedia data is sequentially transmitted from a source such as a server to a reproducing device via a network. In the reproducing device, the divided multimedia data is reproduced while the data is being received.

In a case where a purpose is to watch and listen to such multimedia data, the storage type system in the two transfer systems causes problems related to, for example, storage capacity of the storage device, copyrights of such multimedia data because the storage type system is a system where multimedia data is stored in a storage device and used. From this reason, normally, the streaming type system is used for watching and listening to multimedia data obtained via a network. An example of techniques for reproducing multimedia data by using the streaming type system is a data transmission device disclosed in Patent Document 1 (Japanese Unexamined Patent Publication, Tokukai, No.2005-333568 (published on Dec. 2, 2005)). In the data transmission device disclosed in Patent Document 1, coded video data is transmitted by unidirectional streaming via a network, so that the video data can be transferred by using IP network.

A communication method made between devices includes a method in which RF (Radio Frequency) is used such as WiFi (registered trademark), Bluetooth (registered trademark), or UWB (Ultra Wide Band), and a method in which light is used such as infrared radiation (optical space communication).

The method using RF has an advantage that a communication is available in all direction, and data can pass through even in a shielded environment and be transmitted, whereas the method has a disadvantage that data cannot be continuously transmitted in the same frequency band. From this reason, the communication method using RF is adopted in a method such as the aforementioned reproduction method of streaming type, in which multimedia data is divided and transmitted.

On the other hand, the optical space communication has an advantage that a band in a visible range can be exclusively used, whereas the optical space communication has a disadvantage that, if an environment is shielded or an optical axis deviates from an appropriate position, a communication is interrupted because the optical space communication has directivity, that is to say, the communication is easily disconnected. On this account, the optical space communication is used in a case where multimedia data is converted into analogue signals and then transmitted, or in a case where multimedia data is transmitted by S/PDIF which is a standard for input and output of digital signals of audio data.

However, such conventional arrangements cause a problem that natural reproduction of streaming data cannot be realized by using a directional wireless communication such as an optical space communication.

More specifically, the transmitting of data by using the streaming type system is effective for a case where data is transmitted with high-compression ratio. However, in a directional wireless communication such as an optical space communication, it is frequently necessary to adopt a process for reestablishing the disconnected communication. This is because a communication is easily disconnected, as has been already described.

In a case where a communication is established in an optical space communication, for example, as illustrated in FIG. 14, a transmitter 101, which transmits data, transmits a connection request, and a receiver 103 transmits a connection confirmation in response to the connection request. FIG. 14 is a view of a conventional technique, illustrating an example of a communication between a transmitter for transmitting data and a receiver for receiving the transmitted data. In FIG. 14, parts enclosed by a dashed line illustrate processes carried out in a transmitter 101 and a receiver 103, respectively. Each of the dashed line parts illustrating the processes in the transmitter 101 and the receiver 103 is divided by a full line at a center. In the transmitter 101, a left-hand side of the full line illustrates a process carried out in an upper layer such as an application layer, and a right-hand side of the full line illustrates a process carried out in a lower layer such as a network layer. In the receiver 103, a left-hand side of the full line illustrates a process carried out in a lower layer, and a right-hand side illustrates a process carried out in an upper layer.

When a communication is to be established, in the transmitter 101, a function of an application protocol section in the application layer, i.e., the upper layer, is booted up, and a plurality of commands (not shown) for searching the receiver 103 are transmitted from the transmitter 101. Upon receiving a response from the receiver 103 which has received any of the transmitted commands, the transmitter 101 outputs to toward the receiver 103 a connection request command including a parameter for requesting a connection. The connection request command is subjected to a process for transmission in the low layer, and is then transmitted to the receiver 103 via a communication pathway (network). When the lower layer receives the connection request command, the receiver 103 outputs a connection confirmation command in response to the connection request command at its upper layer. Then, the connection confirmation command is transmitted from the receiver 103 to the transmitter in an inverse manner to the connection request command.

In this way, a communication between the transmitter 101 and the receiver 103 is established through a plurality of processes such as a process for searching a communication destination, and a process for recognizing the communication destination and then transmission and reception of parameters which are necessary for a connection. After the communication between the transmitter and the receiver has been established, data is transmitted at a specified time interval.

Thus, the conventional method requires time until a communication is established. As a result, once a communication is disconnected due to some fault, it takes a considerable amount of time to reestablish the disconnected communication. Especially, in the streaming type system in which a real-time reproduction is carried out, once a connection is interrupted, it takes a long time until the reproduction resumes. Consequently, a natural reproduction cannot be carried out in a receiver.

As has been already described, in the method using an optical space communication in which multimedia data is converted into analogue signals and transmitted, or multimedia data is transmitted by S/PDIF, the following problems arise. In a case where multimedia data is converted into analogue signals and transmitted, since a process for converting the data to analogue is required when the data is transmitted, it is not possible to reproduce the multimedia data well with the use of a method like a streaming type system in which real-time reproduction is carried out. In a case where data is transmitted by the S/PDIF standard, it is merely possible to transmit, for example, information of audio data because a compression ratio is low.

### SUMMARY OF THE INVENTION

An object of the present invention is to provide a receiver, a transmitter, a communication system, a method for controlling a receiver, a communication method, a program for controlling a receiver, and a storage medium for storing the program, each of which allows streaming data to be naturally reproduced with the use of a directional wireless communication.

In order to achieve the above object, a receiver of the present invention is a receiver which establishes a communication, by a directional wireless communication, between the receiver and a transmitter that transmits data, and which receives the data from the transmitter, the transmitter transmitting connection request information for requesting a connection between the transmitter and the receiver to the receiver at a predetermined period, and the transmitter transmitting data related to the connection request information to the receiver after transmitting the connection request information, said receiver comprising: a communication device for establishing a communication between the transmitter and the receiver, and for releasing the communication thus established; a release control section for carrying out a control with respect to the communication device to release the communication thus established between the transmitter and the receiver; and an establishment control section which controls the communication device so that a connection between the transmitter and the receiver is established in accordance with the connection request information, in a case where the connection request information is received from the transmitter while the communication established between the transmitter and the receiver is released in accordance with the control with respect to the communication device which control is carried out by the release control section.

Consequently, the receiver of the present invention has an effect to realize a natural reproduction of streaming data with the use of a directional wireless communication.

Moreover, in order to achieve the above object, a transmitter of the present invention is a transmitter which establishes a communication between the transmitter and a receiver by a directional wireless communication, said receiver including: a communication device for establishing a communication between the transmitter that transmits data and the receiver, and for releasing the communication thus established; a release control section for carrying out a control with respect to the communication device to release the communication thus established between the transmitter and the receiver; and an establishment control section which controls the communication device so that a connection is established between the transmitter and the receiver, wherein the establishment control section controls the communication device so that a connection between the transmitter and the receiver is established in accordance with connection request information for requesting a connection between the transmitter and the receiver, in a case where the connection request information is received from the transmitter while the communication established between the transmitter and the receiver is released in accordance with the control with respect to the communication device which control is carried out by the release control section, said transmitter comprising: a connection request information transmitting section for transmitting the connection request information at a predetermined period; and a data transmission section for transmitting the data related to the connection request information after transmitting the connection request information.

Consequently, the transmitter of the present invention has an effect to realize a natural reproduction of streaming data with the use of a directional wireless communication.

Furthermore, in order to achieve the above object, a communication system of the present invention includes: a transmitter which transmits data; and a receiver which establishes a communication, by a directional wireless communication, between the receiver and the transmitter, and which receives the data from the transmitter, the transmitter transmitting connection request information for requesting a connection between the transmitter and the receiver to the receiver at a predetermined period, and the transmitter transmitting data related to the connection request information to the receiver after transmitting the connection request information, said receiver including: a communication device for establishing a communication between the transmitter and the receiver, and for releasing the communication thus established; a release control section for carrying out a control with respect to the communication device to release the communication thus established between the transmitter and the receiver; and an establishment control section which controls the communication device so that a connection between the transmitter and the receiver is established in accordance with the connection request information, in a case where the connection request information is received from the transmitter while the communication established between the transmitter and the receiver is released in accordance with the control with respect to the communication device which control is carried out by the release control section, said transmitter including: a connection request information transmitting section for transmitting connection request information for requesting a connection at a predetermined period; and a data transmission section for transmitting the data related to the connection request information after transmitting the connection request information.

Consequently, the communication system of the present invention has an effect to realize a natural reproduction of streaming data with the use of a directional wireless communication.

Further, in order to achieve the above object, a method for controlling a receiver is a method for controlling a receiver which establishes a communication, by a directional wireless communication, between the receiver and a transmitter that transmits data, and which receives the data from the transmitter, the transmitter transmitting connection request information for requesting a connection between the transmitter and the receiver to the receiver at a predetermined period, and the transmitter transmitting data related to the connection request information to the receiver after transmitting the connection request information, said method comprising the steps of: (i) releasing a communication established between the transmitter and the receiver; and (ii) causing a connection between the transmitter and the receiver to be established in accordance with the connection request information, in a case where the connection request information is received from the transmitter while the communication established between the transmitter and the receiver is released in accordance with the step (i).

Consequently, the method of the present invention for controlling a receiver has an effect to realize a natural reproduction of streaming data with the use of a directional wireless communication.

Additional objects, features, and strengths of the present invention will be made clear by the description below. Further, the advantages of the present invention will be evident from the following explanation in reference to the drawings.

### BRIEF DESCRIPTION OF THE DRAWINGS

FIG. 1 is a functional block diagram illustrating a software arrangement of a receiver and a transmitter for a connection establishing process in accordance with the embodiment of the present invention.

FIG. 2 is a block diagram schematically illustrating an arrangement of a communication system in accordance with the embodiment of the present invention.

FIG. 3 is a block diagram illustrating a main arrangement of the hardware of the transmitter for the transfer process of the video data, in accordance with the embodiment of the present invention.

FIG. 4 is a block diagram illustrating a main arrangement of the hardware of the receiver for the transfer process of the video data, in accordance with the embodiment of the present invention.

FIG. 5 is an explanatory diagram illustrating a software arrangement of the transmitter and the receiver for transmission and reception of video data, in accordance with the embodiment of the present invention.

FIG. 6 is an explanatory diagram illustrating one example of how a communication is established between the transmitter and the receiver in the communication system of the embodiment.

FIG. 7 is illustrates one example of the embodiment of the present invention in which information which is transmitted from the transmitter to the receiver.

FIG. 8 illustrates one example of the embodiment of the present invention in which a communication scheme which is used in a communication system.

FIG. 9 is an explanatory diagram illustrating how a communication reestablishment is carried out when an error occurs, in accordance with an embodiment of the present invention

FIG. 10 is a sequence view illustrating one example of another communication scheme in the communication system of the embodiment.

FIG. 11 is a functional block diagram illustrating another software arrangement of the transmitter and the receiver for data transmission and reception process, in accordance with the embodiment of the present invention.

FIG. 12 is an explanatory diagram illustrating one example of how a communication is established between a transmitter and a receiver in the communication system 100 of the present embodiment

FIG. 13 is an explanatory diagram illustrating how a communication is reestablished when an error occurs, in accordance with the embodiment of the present invention

FIG. 14 is a view of a conventional technique, illustrating one example of a communication between a transmitter which transmits data and a receiver which receives the transmitted data.

### DESCRIPTION OF THE EMBODIMENTS

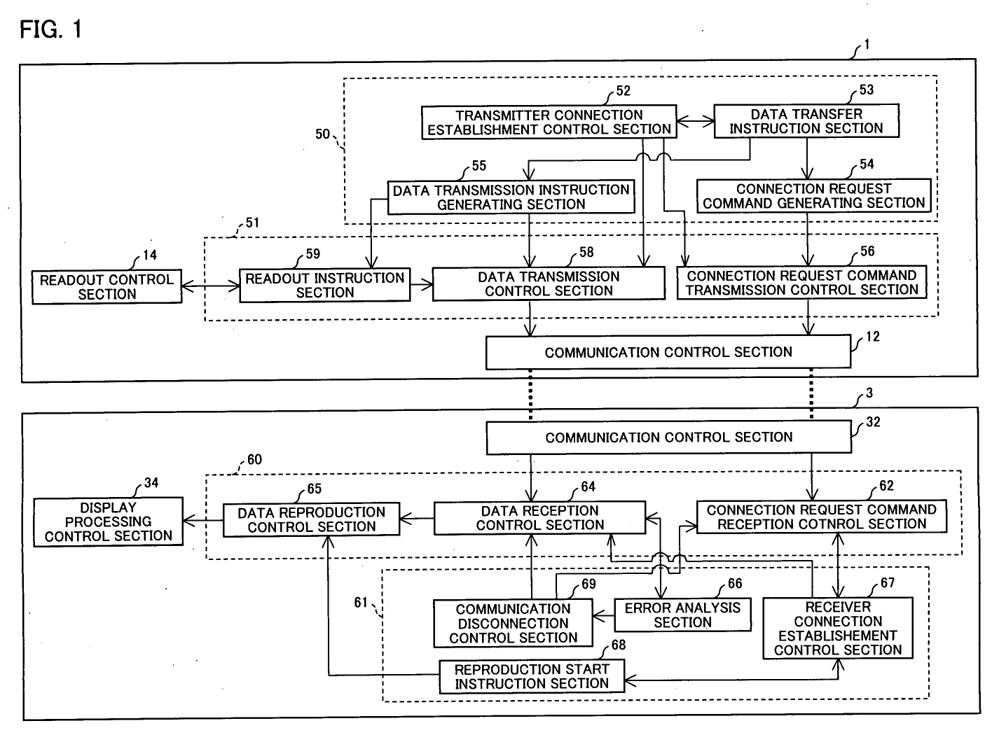

One embodiment of the present invention is described below with reference to FIGS. 1 through 13. A communication system 100 of the present embodiment is a communication system in which video data 5, which is dealt with by a transmitter 1, is sent to a receiver 3 and the video data 5 is reproduced. The communication system 100 of the present embodiment establishes a connection between devices so that data is transmitted between the devices. This system can change a transfer speed of data to be transmitted, and is therefore different from a system in which video data is delivered by a broadcast.

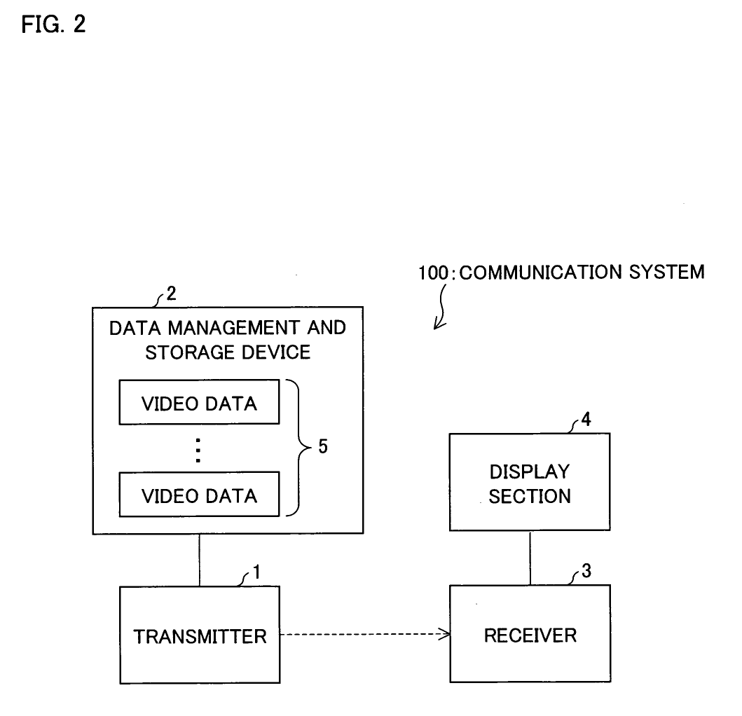

As illustrated in FIG. 2, a communication system 100 includes a transmitter 1, a data management and storage device 2, a receiver 3, and a display section 4. FIG. 2 is a block diagram schematically illustrating an arrangement of the communication system 100 in accordance with the embodiment of the present invention.

The transmitter 1 transmits target video data 5 to the receiver 3. Note that the target video data 5 is the one which is requested for transmission among a plurality of video data 5 managed in the data management and storage device 2. The transmitter 1 divides the target video data 5 into a plurality of packets, and sequentially transmits the plurality of packets to the receiver 3.

Meanwhile, the receiver 3 receives the plurality of packets of the video data 5 transmitted from the transmitter 1. The receiver 3 sequentially transmits the received packets of the video data 5 to the display section 4 so that the display section 4 reproduces the video data in real time. A communication between the transmitter 1 and the receiver 3 is established by an infrared communication.

A mobile phone device, a personal computer, a PDA, a video camera or other device is applicable as the transmitter 1 in the communication system 100 of the present embodiment. A television, a DVD recorder, a hard disk device, a personal computer or other device is applicable as the receiver 3.

(Hardware Arrangement of Transmitter for Transfer Process)

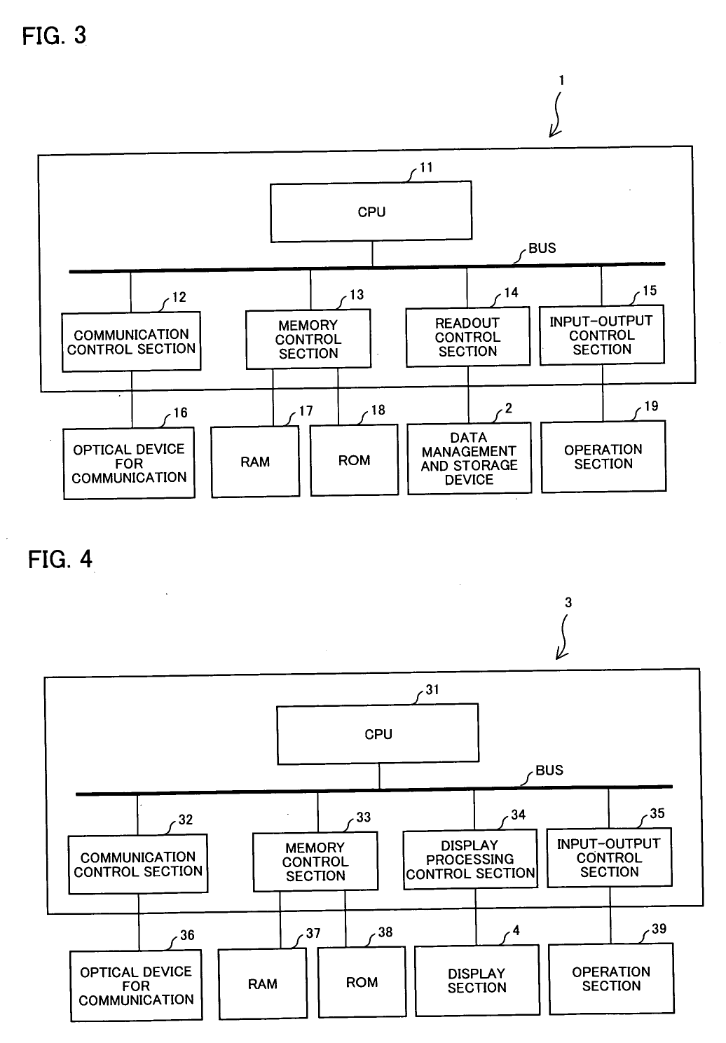

Here, an arrangement of the transmitter 1 in the communication system 100 is explained. Firstly, a hardware arrangement of the transmitter 1 for a transfer process of video data 5 is described with reference to FIG. 3. FIG. 3 is a block diagram illustrating a main arrangement of the hardware of the transmitter 1 for the transfer process of the video data 5.

As illustrated in FIG. 3, the transmitter 1 in accordance with the present embodiment is arranged such that a control circuit for controlling an external LSI and the like is connected to a CPU 11 via a bus. The control circuit includes a communication control section 12, a memory control section 13, a readout control section 14, and an input-output control section 15. The control sections are respectively controlled by control instructions from the CPU 11 that generally manages each of the sections in the transmitter 1.

More specifically, the communication control section 12 controls and drives an optical device 16 for communication in response to a control signal from the CPU 11 so as to carry out an infrared communication with the receiver 3. The optical device 16 for communication converts data into an optical signal and transmits the optical signal to the receiver 3 by an infrared radiation, in response to a control instruction from the communication control section 12.

The memory control section 13 reads out information from a RAM 17 and a ROM 18 or stores such information, in response to a control signal from the CPU 11. For example, the memory control section 13 reads out programs for various controls from the ROM 18, and loads the programs on the RAM 17, and transmits information to the CPU 11.

The readout control section 14 manages readout of video data 5 stored in the data management and storage device 2. The readout control section 14 reads out the video data 5 from the data management and storage device 2 and transmits the video data 5 to the communication control section 12, in response to a control signal from the CPU 11.

The input-output control section 15 receives each instruction entered from an operation section 19. The input-output control section 15 transmits each of the entered instructions, for example, to the CPU 11. The operation section 19 is an interface that handles entering of information by which user instructs the transmitter 1 to start or end each process for example.

(Hardware Arrangement of Receiver for Transfer Process)

The following description deals with a hardware arrangement of the receiver 3 for a transfer process of video data 5 with reference to FIG. 4. FIG. 4 is a block diagram illustrating a main arrangement of the hardware of the receiver 3 for the transfer process of the video data 5, in accordance with the embodiment of the present invention.

As illustrated in FIG. 1, the receiver 3 of the present embodiment is arranged such that a control circuit for controlling an external LSI and the like is connected to a CPU 31 via a bus. The control circuit includes a communication control section 32, a memory control section 33, a display processing control section 34, and an input-output control section 35 in the same manner as the aforementioned transmitter 1. The control sections are respectively controlled by control instructions from the CPU 31. The hardware arrangement of the receiver 3 is different from that of the transmitter 1 in that the receiver 3 includes the display processing control section 34 for supplying data to and controlling a display section 4 so that the display section 4 carries out a display, instead of the readout control section 14 for reading out data from the data management and storage device 2.

Accordingly, members other than the display processing control section 34, that is, the CPU 31, the communication control section 32, the memory control section 33, the input-output control section 35, an optical device for communication 36, a RAM 37, a ROM 38, and an operation section 39 respectively work in the same manner as the CPU 11, the communication control section 12, the memory control section 13, the input-output control section 15, the optical device for communication 16, the RAM 17, the ROM 18, and the operation section 19. From this reason, explanations about each section are not provided here.

(Software Arrangement of Transmitter and Receiver for Transfer Process)

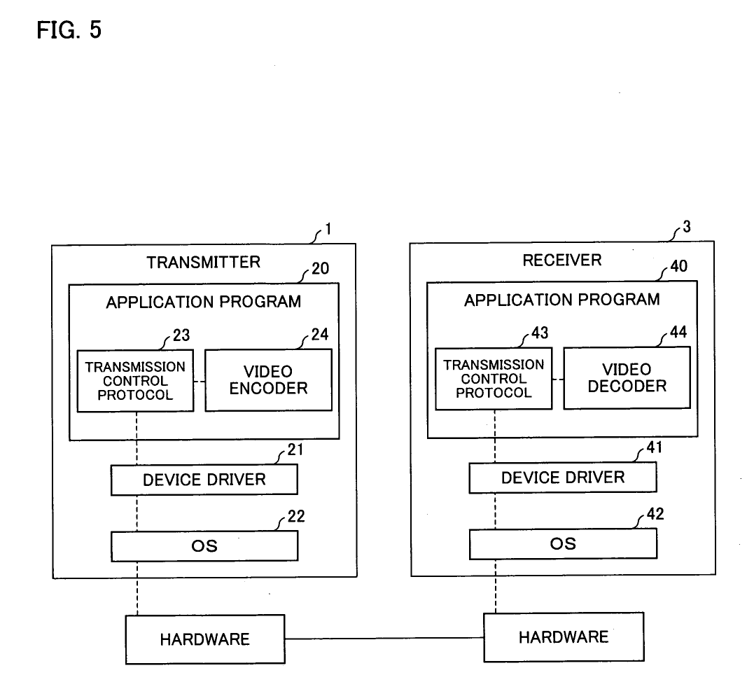

The transmitter 1 and the receiver 3, which have the aforementioned hardware arrangements, have softwares illustrated in FIG. 5. FIG. 5 is an explanatory diagram illustrating a software arrangement of the transmitter 1 and the receiver 3 for transmission and reception of video data 5, in accordance with the embodiment of the present invention.

As illustrated in FIG. 5, the transmitter 1 includes an application program 20, a device driver 21, and an OS 22 as softwares for transmission and reception of video data 5. The transmitter 1 executes the softwares for controlling its hardware so that the video data 5 is transmitted to the receiver 3.

The application program 20 includes: a video encoder 24, which is a software for encoding video data 5 to be transmitted so that the video data 5 is converted into a data format whereby the video data 5 can be delivered by streaming; and a transmission control protocol 23 for providing controls for transmitting the encoded video data 5 to the receiver 3.

On the other hand, the receiver 3 includes an application program 40, a device driver 41, and an OS 42 as softwares for transmission and reception of video data 5. The receiver 3 executes the softwares for controlling its hardware so that the receiver 3 receives the video data 5 from the transmitter 1.

The application program 40 includes a transmission control protocol 43 for providing controls for receiving the video data transmitted from the transmitter 1; and a video decoder 44, which is a software for decoding the received video data.

In the transmitter 1 and the receiver 3, each of the softwares is executed such that, according to time-sharing or occurrence of an interrupt, the OS 22 and the OS 42 respectively determine which software is to be executed in accordance with a predetermined priority.

(Functional Block of Receiver and Transmitter for Connection Establishing Process)

Then, the following description deals with in detail an arrangement of the receiver 3 and the transmitter 1 for a connection establishing process between the transmitter 1 and the receiver 3 with reference to FIG. 1. FIG. 1 is a functional block diagram illustrating a software arrangement of the receiver 3 and the transmitter 1 for a connection establishing process in accordance with the embodiment of the present invention.

The connection establishing process is a process for establishing a connection so that the transmitter can transfer video data to the receiver 3.

(Functional Block of Transmitter)

A software arrangement of the transmitter 1 is described below with reference to a functional block illustrated in FIG. 1.

As illustrated in FIG. 1, the transmitter 1 includes a transmitter upper layer processing section 50 and a transmitter lower layer processing section 51 as its functional blocks. The transmitter upper layer processing section 50 controls processes which are carried out in an upper layer such as an application layer, and includes a transmitter connection establishment control section 52, a data transfer instruction section 53, a connection request command generating section 54, and a data transmission instruction generating section 55.

The transmitter lower layer processing section 51 controls processes which are carried out in a lower layer such as a network layer, and includes a connection request command transmission control section 56, a data transmission control section 58, a readout instruction section 59.

The functional blocks can be realized as follows. The CPU 11 instructs the memory control section 13 to cause (i) a program to be to read out from the ROM 18, (ii) the program to be loaded on the RAM 17, and (iii) the program to be executed, thereby realizing the functional blocks. That is, the functional blocks functionally illustrate various controls (i) causing the transmission control protocol 23 and the video encoder 24, each stored as the application program 20, to be executed under the OS22, and (ii) causing the device driver 21 to instruct the hardware so that the hardware works in accordance with the results obtained by the execution of the transmission control protocol 23 and the video encoder 24. A data transmission section and a completion information transmitting section of the present invention are realized by the communication control section 12 and the data transmission control section 58. A connection request information transmitting section of the present invention is realized by the communication control section 12 and the connection request command transmission control section 56.

The transmitter connection establishment control section 52 carries out controls related to a connection establishment between the transmitter 1 and the receiver 3. More specifically, in cases where the transmitter connection establishment control section 52 outputs a connection request to the data transfer instruction section 53 and receives a connection confirmation which is a response to the connection request, the transmitter connection establishment control section 52 determines that a pseudo-connection between the transmitter 1 and the receiver 3 has been established, and then changes the transmitter 1 into a connection establishment state.

The connection establishment state is a state in which the transmitter 1 determines that a connection between the transmitter 1 and the receiver 3 has been established. This does not necessarily mean that a connection between the transmitter 1 and the receiver 3 is actually established. On this account, in a communication scheme of the communication system 100 in accordance with the present embodiment, the transmitter 1 does not ask the receiver 3 about information indicating a confirmation (connection confirmation) in response to the connection request. To put it differently, the transmitter 1 never receives from the receiver 3 a response to its connection request. From this reason, a state in which a pseudo-connection is established is realized by generating a connection request in the transmitter 1 and by generating a response to the connection request in the transmitter 1, as described later.

When the transmitter 1 is changed into a connection establishment state, the transmitter connection establishment control section 52 outputs the following instructions as connection establishment control instructions.

The transmitter connection establishment control section 52 instructs respectively the connection request command transmission control section 56 and the data transmission control section 58 to establish a communication pathway between the transmitter 1 and the receiver 3. The transmitter connection establishment control section 52 also instructs the data transfer instruction section 53 to prepare transmissions of a connection request command (connection request information) 6, a packet group (data) 7, and a disconnection request command (completion information) 8.

The connection request command 6 is control information including a parameter and the like which are necessary for establishing a connection between the transmitter 1 and the receiver 3. The packet group 7 is a group of a certain amount of data packets, which is received by the receiver 3. The disconnection request command 8 is information indicating that transmission of the packet group 7 corresponding to the connection request command 6 has been completed. As such, the connection request command 6, the packet group 7, and the disconnection request command 8 are related to each other, and the receiver 3 manages initiation and completion of data transmission by considering the two commands and the one packet group as one set.

The data transfer instruction section 53 sends a connection confirmation to the transmitter connection establishment control section 52 upon receiving a connection request supplied from the transmitter connection establishment control section 52, as described above. Moreover, after the transmitter 1 is changed into a connection establishment state, the data transfer instruction section 53 receives, from the transmitter connection establishment control section 52, an instruction to prepare transmissions of a connection request command 6, a packet group 7, and a disconnection request command 8. In response to the instruction, the data transfer instruction section 53 instructs (i) the connection request command generating section 54 to generate the connection request command 6, and (ii) the data transmission instruction generating section 55 to generate a data transmission instruction command and a disconnection request command 8. Here, the data transmission instruction command is control information to instruct the communication control section 12 to read out the packet group 7 to be transmitted to the receiver 3 and transmit the packet group 7.

The connection request command generating section 54 generates a connection request command 6 in response to an instruction from the data transfer instruction section 53. After the transmitter 1 is changed into a connection establishment state, the connection request command generating section 54 generates a connection request command 6 at a predetermined period, and transmits the connection request command 6 to the connection request command transmission control section 56.

The data transmission instruction generating section 55 generates a data transmission instruction command and a data disconnection request command 8 in response to an instruction from the data transfer instruction section 53. After the transmitter 1 is changed into a connection establishment state, the data transmission instruction generating section 55 generates a data transmission instruction command at a predetermined period, and transmits the data transmission instruction command to the readout instruction section 59. Meanwhile, the data transmission instruction generating section 55 similarly generates a disconnection request command 8 at a predetermined period, and transmits the disconnection request command 8 to the data transmission control section 58.

In response to an instruction of the transmitter connection establishment control section 52, the connection request command transmission control section 56 controls the communication control section 12 so that a physical connection is established between the transmitter 1 and the receiver 3, and then causes the connection request command 6, received from the connection request command generating section 54, to be transmitted to the receiver 3 as a packet.

In response to an instruction from the transmitter connection establishment control section 52, the data transmission control section 58 controls the communication control section 12 so that a physical connection is established between the transmitter 1 and the receiver 3, and then causes the video data 5 thus read out to be compressed and transmitted to the receiver 3 as a packet group 7 constituted by a plurality of data packets. Subsequently, the data transmission control section 58 transmits to the receiver 3 the disconnection request command 8 received from the data transmission instruction generating section 55.

The readout instruction section 59 instructs a readout control section 14 to read out the video data 5 from the data management and storage device 2 in response to the data transmission instruction command received from the data transmission instruction generating section 55. The readout instruction section 59 supplies the video data 5 thus read out to the data transmission control section 58 so that the video data 5 is transmitted to the receiver 3.

(Functional Block of Receiver)

A software arrangement of the receiver 3 is described below with reference to the functional block diagram illustrated in FIG. 1.

As illustrated in FIG. 1, the receiver 3 includes a receiver upper layer processing section 61 and a receiver lower layer processing section 60 as its functional blocks. The receiver upper layer processing section 61 controls processes which are carried out in an upper layer such as an application layer in the receiver 3, and includes an error analysis section (error determination section) 66, a receiver connection establishment control section 67, a reproduction start instruction section 68, and a communication disconnection control section 69.

The receiver lower layer processing section 60 controls processes which are carried out in a lower layer such as a network layer in the receiver 3, and includes a connection request command reception control section 62, a data reception control section 64, and a data reproduction control section 65.

The functional blocks can be realized as follows. The CPU 31 instructs the memory control section 33 to cause (i) a program to be read out from the ROM 38, (ii) the program to be loaded on the RAM 37, and (iii) the program to be executed, thereby realizing the functional blocks. That is, the functional blocks functionally illustrates various controls (i) causing the transmission control protocol 43 and the video decoder 44, each stored as the application program 40, to be executed in the OS42, and (ii) causing the device driver 41 to instruct the hardware so that the hardware works in accordance with the results obtained by the execution of the transmission control protocol 43 and the video decoder 44.

A data reception section and a completion information receiving section of the present invention is realized by the communication control section 32 and the data reception control section 64. A connection request information receiving section of the present invention is realized by the communication control section 21 and the connection request command reception control section 62.

The error analysis section 66 analyzes whether or not an error occurs in a communication between the transmitter 1 and the receiver 3. The detail will be later described as to how the error analysis section 66 determines whether or not an error occurs.

The receiver connection establishment control section 67 outputs a connection establishment control instruction causing a connection establishment between the transmitter 1 and the receiver 3 to be controlled. More specifically, in cases where the receiver connection establishment control section 67 outputs a connection request based on a connection request command 6 received from the transmitter 1 to the reproduction start instruction section 68 and receives a connection confirmation which is a response to the connection request, the receiver connection establishment control section 67 determines that a pseudo-connection between the transmitter 1 and the receiver 3 has been established, and then changes the receiver 3 into a connection establishment state.

The connection establishment state is a state in which the receiver 3 determines that a connection between the transmitter 1 and the receiver 3 has been established. That is, in a communication scheme of the communication system 100 in accordance with the present embodiment, the receiver 3 does not transmit a reception confirmation to the transmitter 1 in response to a connection request command 6 received from the transmitter 1. On this account, a connection confirmation is generated in the receiver 3 as a response to a connection request based on the connection request command 6 received from the transmitter 1. Based on the connection confirmation thus generated in the receiver 3, the receiver connection establishment control section 67 determines that a connection has been established between the transmitter 1 and the receiver 3.

After the receiver 3 is changed into a connection establishment state, the receiver connection establishment control section 67 outputs the following instructions as connection establishment control instructions.

The receiver connection establishment control section 67 causes respectively the connection request command reception control section 62 and the data reception control section 64 to maintain a communication pathway so that a connection request command 6, a packet group 7, and a disconnection request command can be successively received. The receiver connection establishment control section 67 also instructs the reproduction start instruction section 68 to prepare reproduction of the received packet group 7.

The reproduction start instruction section 68 sends a connection confirmation to the receiver connection establishment control section 67 upon receiving a connection request supplied from the receiver connection establishment control section 67, as described above. Moreover, after the receiver 3 is changed into a connection establishment state, the reproduction start instruction section 68 receives an instruction to prepare reproduction of the packet group 7 from the receiver connection establishment control section 67. The reproduction start instruction section 68 instructs the data reproduction control section 65 to reproduce the packet group 7 which is received by the data reception control section 64, in response to the instruction from the receiver connection establishment control section 67.

The communication disconnection control section 69 outputs a disconnection control instruction causing a disconnection of the receiver 3 from the transmitter 1. More specifically, the communication disconnection control section 69 changes the receiver 3 into a disconnection state when the error analysis section 66 determines that an error has occurred.

Note that the disconnection state is a state in which the receiver 3 determines that the communication between the transmitter 1 and the receiver 3 has been disconnected. The communication disconnection control section 69 supplies a disconnection control instruction to the connection request command reception control section 62 and the data reception control section 64 so that the communication between the transmitter 1 and the receiver 3 is disconnected.

The connection request command reception control section 62 controls the communication control section 32 in response to an instruction from the receiver connection establishment control section 67 so that a physical connection between the transmitter 1 and the receiver 3 is maintained. A receiver 3 of the present embodiment is arranged such that, once a connection between the transmitter 1 and the receiver 3 has been established and maintained, a process for reconnection between the transmitter 1 and the receiver 3 is not carried out even if the receiver 3 receives a new packet of the connection request command 6 from the transmitter 1. That is, the receiver 3 is arranged such that, while no error occurs between the transmitter 1 and the receiver 3 after the receiver 3 is changed into a connection establishment state, i.e., in a case where the receiver 3 is not changed into a disconnection state, a new connection is not separately established even if the connection request command reception control section 62 receives a connection request command 6.

Moreover, the connection request command reception control section 62 controls the communication control section 32 in response to an instruction from the communication disconnection control section 69 so that a communication between the transmitter 1 and the receiver 3 is disconnected, in other words, so that the establishment of the communication is released. In the communication disconnection state, upon receiving a new packet of the connection request command 6 from the transmitter 1, the connection request command reception control section 62 analyzes the packet and transmits an analysis result to the receiver connection establishment control section 67. When the receiver 3 receives a connection request command 6 in a state where the receiver is not changed into a connection establishment state, in other words, in a state where a connection between the transmitter 1 and the receiver 3 has not been established, the receiver 3 outputs a connection request which is based on the connection request command 6 to the receiver connection establishment control section 67.

The data reception control section 64 controls the communication control section 32 in response to an instruction from the receiver connection establishment control section 67 so that a physical connection between the transmitter 1 and the receiver 3 is maintained. Once a connection between the transmitter 1 and the receiver 3 has been established, the data reception control section 64 maintains the connection, and stands by so that the transmitter can receive a packet group 7 from the transmitter 1. It follows that the data reception control section 64 maintains an establishment of a communication for data transmission from the transmitter 1.

The data reception control section 64 also controls the communication control section 32 in response to an instruction from the communication disconnection control section 69 so that a communication established between the receiver 3 and the transmitter 1 is released. Moreover, the data reception control section 64 is so arranged not to receive a disconnection request command and a packet group 7 each transmitted from the transmitter 1 until receiving a connection establishment control instruction from the receiver connection establishment control section 67.

Upon receiving a packet group 7 from the transmitter 1, the data reception control section 64 transmits the packet group 7 to the data reproduction control section 65.

The data reproduction control section 65 decodes a packet group 7 received from the transmitter 1, and outputs the packet group 7 thus decoded to the display processing control section 34. Then, the data reproduction control section 65 controls the display processing control section 34 so that image which is based on the packet group 7 is displayed.

A release control section of the present invention is realized by the communication disconnection control section 69 and the data reception control section 64. A release control section is realized by the communication disconnection control section 69 and the connection request command reception control section 62. An establishment control section of the present invention is realized by the receiver connection establishment control section 67 and the data reception control section 64. An establishment control section of the present invention is realized by the receiver connection establishment control section 67 and the connection request command reception control section 62.

(Communication Establishing Process)

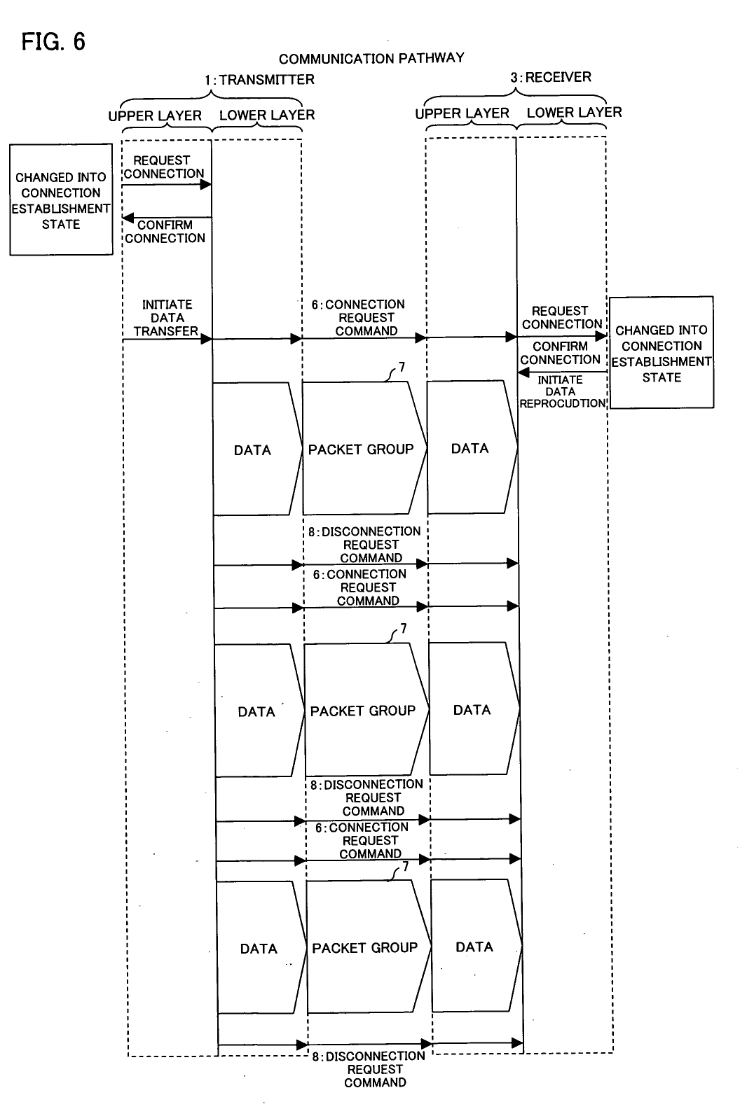

Details of a communication establishing process for transmission of a packet group 7 between the transmitter 1 and the receiver 3 are described below with reference to FIGS. 6 through 8. FIG. 6 is an explanatory diagram illustrating one example of a communication establishing process between the transmitter 1 and the receiver 3 in the communication system 100 of the present embodiment. In FIG. 6, regions enclosed by dashed lines respectively illustrate processes carried out in the transmitter 1 and in the receiver 3. Each of the dashed line parts illustrating the processes in the transmitter 1 and in the receiver 3 is divided by a full line at a center. In the transmitter 1, a left-hand side of the full line illustrates a process carried out in an upper layer such as an application layer, and a right-hand side of the full line illustrates a process carried out in a lower layer such as a network layer. In the receiver 3, a left-hand side of the full line illustrates a process carried out in a lower layer, and a right-hand side of the full line illustrates process carried out in an upper layer.

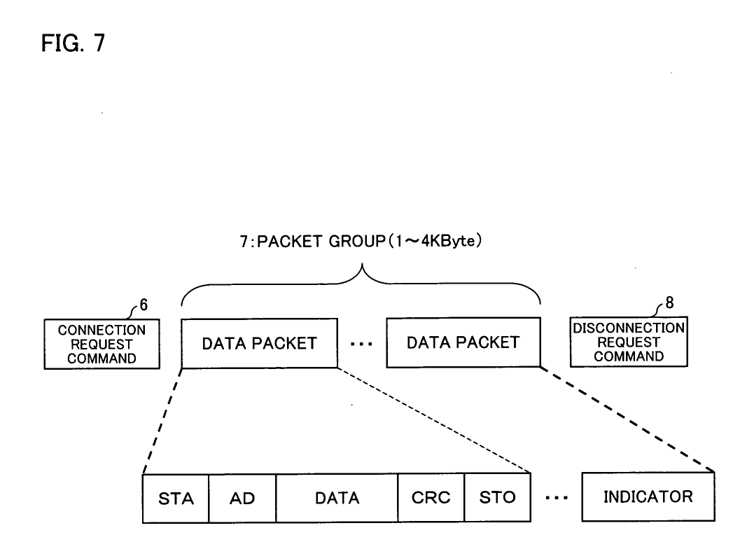

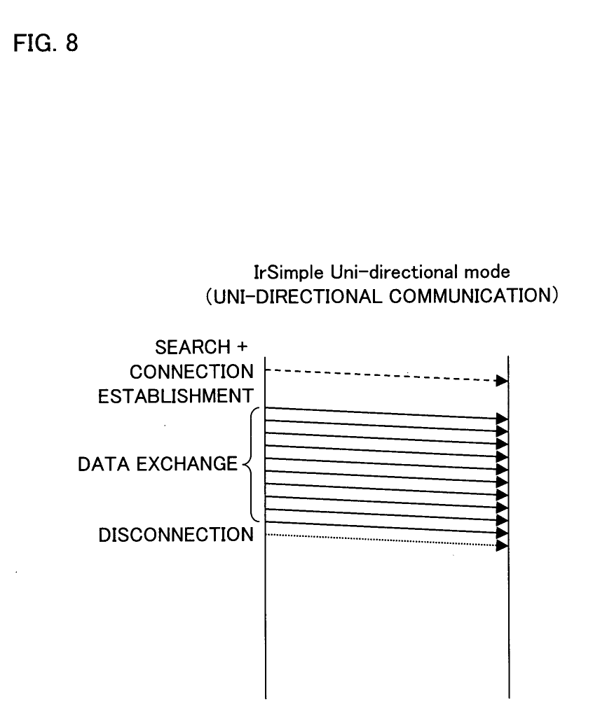

FIG. 7 illustrates one example of the embodiment of the present invention in which information which is transmitted from the transmitter 1 to the receiver 3. FIG. 8 illustrates one example of the embodiment of the present invention in which a communication scheme which is used in a communication system.

Before explaining about a communication establishing process in the communication system 100 of the present embodiment, details of a connection request command 6, a packet group 7, and a disconnection request command, which are transferred between the transmitter 1 and the receiver 3, are described below with reference to FIG. 7.

(Connection Request Command, Packet Group, and Disconnection Request Command)

According to a communication system 100 in accordance with the present embodiment, a connection request command 6 is firstly transmitted, then a packet group 7 is transmitted, and finally a packet containing a disconnection request command 8 is transmitted (see FIG. 7).

Here, each of data packets in the packet group 7 includes: an information indicating a top of a data packet (“STA” in FIG. 7), and an address indicating a transmission destination (“AD” in FIG. 7), each of which comes before data; and information for checking an error (“CRC” in FIG. 7) and information indicating an end of the data (“STO” in FIG. 7), each of which comes after the data. The data includes an identification number by which a packet is specified, and the identification numbers “0, 1, 2 . . . ” are sequentially assigned to each of the data in the packet group 7 in the order to be transmitted from a headmost packet. This makes it possible to identify the number of each of the data packets in the packet group 7.

The “CRC” has a predetermined length, and the length determines an amount of data for which an error can be detected. More specifically, the “CRC” has a length such as 16 bits or 32 bits. For example, when the length is 16 bits, it is possible to absolutely (100%) detect an error of 1 bit in 4096 bytes (maximal length).

Moreover, as illustrated in FIG. 7, each packet group 7 includes, at its end, information (an indicator) indicating an end of the packet group 7. The information indicating the end is shown by a flag.

The indicator may be added to the end of the packet group 7 as is described above. Alternatively, the indicator may include information on how many data packets the packet group 7 includes, and be added to a headmost data packet of the packet group 7. Alternatively, an indicator may be transmitted independently of a packet group 7 every after transmission of one packet group 7 has been completed.

Each of data packets of a packet group 7, which is transmitted at a predetermined time interval, has a data amount of 1 kilo byte to 2 kilo bytes, and has a transfer speed of 4 Mbps. On the other hand, a transfer speed of the connection request command 6, which is transmitted at a predetermined time interval, is 9600 bps. However, the amount of the data packet, its transfer speed, and the transfer speed of the connection request command 6 are not limited to this. The data amount of the data packet to be transmitted may be in a range of a data amount in which the receiver 3 can determine whether or not an error occurs. The data amount may be, for example, in a range from 1 kilo byte to 16 kilo bytes. It is preferable that, in consideration of first combinations of a data amount and a transfer speed of the connection request command 6 and second combinations of a data amount and a transfer speed of a data packet, combinations for most efficient communication be appropriately selected among the first and second combinations.

The connection request command 6 includes information indicating a correspondence relation to a following packet group 7 to be transmitted after the connection request command 6. The information indicating such a correspondence relation may be information for identifying a following packet group 7 to be transmitted after the connection request command, or may further include an identification number corresponding to each of the data packets constituting the packet group 7.

It is more preferable that a connection request command 6 include information on a following packet group 7 to be transmitted after the connection request command 6. This is because the receiver 3 can check, by data packet unit, whether or not the received packet group 7 corresponds to the connection request command 6 received before the packet group 7.

By receiving a disconnection request command 8, the receiver 3 can recognize that transmission of the packet group 7 from the transmitter 1 has been completed. In the communication system 100 in accordance with the present embodiment, the disconnection request command 8 is transmitted for the following reason.

Each of the data packets constituting the packet group 7 transmitted from the transmitter 1 is assigned to the identification number sequentially in the order of transmission. The receiver 3 checks the identification numbers assigned to each of the data packets in the received packet group 7, and determines based on the checking of the identification numbers whether the packet group 7 has been properly transmitted.

In the communication system 100 in accordance with the present embodiment, a disconnection request command 8 is transmitted every after each transmission of a packet group 7 so that the completion of transmission of the packet group 7 is notified. The communication system 100 is arranged such that, by receiving a connection request command 6 after the disconnection request command 8, the receiver 3 recognizes that a new packet group 7 has started to be transmitted, and resets the identification number to zero for checking the new packet group 7.

In this way, a communication system 100 in accordance with the present embodiment is arranged such that a transmitter 1 transmits a disconnection request command 8 to the receiver 3 after a packet group 7 has been transmitted. With the arrangement, for example, in a case where a communication is interrupted while a packet group 7 is being transmitted, and is then restarted in the middle of transmission of a different packet group 7, the receiver can recognize that there are some data packets that have not been able to be received during interruption of the communication.

In an arrangement in which packet groups 7 are not reset at a predetermined time interval, numbers sequentially assigned to data packets may exceed the upper limit of variable size for the numbers. After the upper limit is exceeded, identification numbers, which will be assigned to data packets of a packet group 7 to be subsequently transmitted, are reset to zero. This causes the identification numbers, assigned to the received data packets, not to be checked. This prevents the data packets from being appropriately reproduced.

However, in a communication system 100 of the present embodiment, a disconnection request command 8 is transmitted. As such, it is possible to avoid such a situation in which the identification numbers of the received data packets cannot be identified because the received data packets overflow.

Thus, according to a communication system 100 of the present embodiment, a disconnection request command 8 improves integrity of data reception.

(Communication Scheme)

A communication scheme which is used in a communication system 100 in accordance with the present embodiment is described below with reference to FIG. 8. As illustrated in FIG. 8, in the communication system 100 in accordance with the present embodiment, an IrSimple uni-directional communication (IrSimple Uni-directional mode) is adopted as a communication scheme. The IrSimple is a communication scheme in which a part of functions of a conventional IrDA is improved, and is arranged such that a packet (a connection request command 6), having both of a function of searching a destination device and a function as a command having necessary parameters for connection, is outputted when a communication starts so that a communication is established, and then a predetermined number of data are transmitted (data exchange), as illustrated in FIG. 8.

This allows largely shortening time required to establish a connection in the communication system 100 in accordance with the present embodiment, as compared with the conventional IrDA.

Furthermore, in the communication scheme, necessary parameters required for a connection are set as default values, unlike the conventional IrDA in which parameters required for a connection are exchanged between devices. Therefore, it is not necessary that a connection request packet include most of the parameters, thereby reducing the size of the connection request packet. This makes it possible to further shorten time for a connection.

(Establishment of Connection)

According to a communication system 100 in accordance with the present embodiment, in the aforementioned communication scheme, a connection between the transmitter 1 and the receiver 3 is to be established as described below, so that the packet group 7, the connection request command 6, and the disconnection request command 8 can be transmitted. The following description deals with a connection establishment process in a communication system 100 in accordance with the present embodiment with reference to FIGS. 1, 3, and 6.

A connection request command causing a connection between the transmitter 1 and the receiver 3 is issued by the operation section 19, and then the input-output control section 15 of the transmitter 1 receives the connection request command. In response to the command thus received, the transmitter connection establishment control section 52 in the transmitter upper layer processing section 50 outputs a connection request to the data transfer instruction section 53. Upon receiving the connection request, the data transfer instruction section 53 sends a connection confirmation as a response to the connection request to the transmitter connection establishment control section 52. This causes the transmitter 1 to determine that a pseudo-connection has been established, and causes a state in the device to be changed into a connection establishment state.

In response to such a connection establishment state, the transmitter connection establishment control section 52 instructs the connection request command transmission control section 56 and the data transmission control section 58 respectively to control the communication control section 12 so that a communication pathway is established. This allows a connection request command 6, a packet group 7, and a disconnection request command 8 to be transmitted. Meanwhile, the transmitter connection establishment control section 52 instructs the data transfer instruction section 53 to prepare transmissions of the connection request command 6, the packet group 7, and the disconnection request command 8.

The data transfer instruction section 53 instructs the connection request command generating section 54 to generate a connection request command 6. Then, the data transfer instruction section 53 instructs the data transmission instruction generating section 55 to generate a data transmission instruction command.

In the communication system 100 in accordance with the present embodiment, video data 5 is transmitted as a packet group 7, which is constituted by a plurality of packets, at a transfer speed of 4 Mbps. In consideration of a transmission period of the connection request command 6 and a data amount of the video data 5 which is to be transmitted as the packet group 7, it is preferable to set a time interval between transmission of a connection request command 6 and transmission of a disconnection request command 8 to a range of 500 mSec to 1 Sec. On this account, a predetermined time interval at which the connection request command generating section 54 generates connection request commands is set to a range of 500 mSec to 1 Sec.

In response to the instruction received from the data transfer instruction section 53, the connection request command generating section 54 generates a connection request command 6 and transmits the command to the connection request command transmission control section 56. The connection request command transmission control section 56 controls the communication control section 12 so that the connection request command 6 is transmitted to the receiver 3 at a predetermined period.

In the receiver 3, the connection request command 6 which has been transmitted from the communication control section 12 is received by the connection request command reception control section 62 in the receiver lower layer processing section 60 via the communication control section 32. Then, the connection request command reception control section 62 transmits the connection request command 6 thus received to the receiver connection establishment control section 67 in the receiver upper layer processing section 61.

The receiver connection establishment control section 67 outputs a connection request, which is based on the received connection request command 6, to the reproduction start instruction section 68. Upon receiving the connection request, the reproduction start instruction section 68 sends a connection confirmation, as a response to the connection request, to the connection establishment control section 67.

When the connection request and the connection confirmation are transmitted and received between the receiver connection establishment control section 67 and the reproduction start instruction section 68, the receiver 3 determines that a pseudo-connection has been established between the transmitter 1 and the receiver 3, and is changed into a connection establishment state.

After the receiver 3 is changed to a connection establishment state, the receiver connection establishment control section 67 instructs the connection request command reception control section 62 and the data reception control section 64 respectively to control the communication control section 32 so that a connection between the transmitter 1 and the receiver 3 is established and its communication pathway is maintained. This allows the connection request command 6, the packet group 7, and the disconnection request command 8 to be received. Furthermore, the receiver connection establishment control section 67 instructs the reproduction start instruction section 68 to prepare reproduction of the received packet group 7.

As described above, the transmitter 1 and the receiver 3 respectively change themselves into their connection establishment states. In response to the connection establishment state, in the transmitter 1, the data transfer instruction section 53 instructs the data transmission instruction generating section 55 to generate a data transmission instruction command and a disconnection request command 8. The data transfer instruction section 53 instructs the data transmission instruction generating section 55 to transmit the generated data transmission instruction command to the readout instruction section 59 so that the readout instruction section 59 instructs the readout control section 14 to read the packet group 7. Meanwhile, the data transfer instruction section 53 instructs the data transmission instruction generating section 55 to transmit the generated disconnection request command 8 to the data transmission control section 58 so that the data transmission control section 58 transmits a packet of the disconnection request command 8 after the packet group 7.

The readout control section 14 reads out the video data 5 in response to the instruction from the readout instruction section 59. The readout instruction section 59 transmits the video data 5 thus read to the data transmission control section 58, and instructs the data transmission control section 58 to transmit the video data 5 to the receiver 3. In response to the instruction from the readout instruction section 59, the data transmission control section 58 compresses the video data 5 thus read, and controls the communication control section 12 so that the video data thus compressed is transmitted to the receiver 3 as a packet group 7 made up of a plurality of data packets. Subsequently, the data transmission control section 58 controls the communication control section 12 to transmit the disconnection request command 8 after the packet group 7 of the video data 5 has been transmitted.

The packet group 7 and the disconnection request command 8 thus transmitted from the transmitter 1 are processed in the receiver 3 as follows.

Under a control instruction from the data reception control section 64, the communication control section 32 receives the packet group 7 from the transmitter 1. The packet group 7 is supplied to the data reception control section 64 so as to be analyzed. The error analysis section 66 determines whether an error occurs in the data packets received from the transmitter 1 based on the analysis result of the data reception control section 64.

When the error analysis section 66 determines that no error occurs in a packet group 7, the packet group 7 is decoded by the data reproduction control section 65, and is then supplied to the display processing control section 34. The data reproduction control section 65 instructs the display processing control section 34 to display the packet group 7 in the display section 4.

In this way, a connection between the transmitter 1 and the receiver 3 is established, so that the packet group 7 can be transmitted.

In the communication system 100 in accordance with the present embodiment, after each of the transmitter 1 and the receiver 3 is changed into a connection establishment state, transmission and reception process of the connection request command 6, the packet group 7, and the disconnection request command 8 are carried out as follows.

As has been already described, the connection request command generating section 54 generates a connection request command 6 at a predetermined period, and instructs the connection request command transmission control section 56 in the transmitter lower layer processing section 51 to transmit the connection request command 6 to the receiver 3. The connection request command transmission control section 56 transmits the connection request command 6 to the receiver 3 via the communication control section 12, in response to the instruction.

The data transmission instruction generating section 55 instructs, at the predetermined period, the readout instruction section 59 to read out the video data 5. In response to the instruction, the readout instruction section 59 instructs the readout control section 14 to read out a predetermined amount of the video data 5. The readout instruction section 59 supplies the read video data 5 to the data transmission control section 58. The data transmission control section 58 compresses the read video data 5 into a packet group 7, and transmits the packet group 7 to the receiver 3 via the communication control section 12. Moreover, the data transmission section 58 generates a packet including a disconnection request command 8, and transmits the packet to the receiver 3 after transmitting the packet group 7.

On the other hand, in the receiver 3, the connection request command reception control section 62 receives the connection request command 6 transmitted from the transmitter 1 after the receiver 3 is changed into the connection establishment state. Note that the receiver 3 is arranged such that, while the receiver 3 stays in a connection establishment state, a reconnection between the transmitter 1 and the receiver 3 is not carried out even if the receiver 3 receives another connection request command 6. That is, in a communication system 100 in accordance with the present embodiment, a receiver 3 is arranged such that, while a connection between a transmitter 1 and a receiver 3 is established, a further connection establishment is not carried out even if the receiver 3 receives a packet including a connection request command 6.

On the other hand, the packet group 7 and the disconnection request command 8 transmitted from the transmitter 1 are received by the data reception control section 64. The data reception control section 64 analyzes the received packet group 7, and supplies a analysis result to the error analysis section 66. When the error analysis section 66 determines that no error occurs in the packet group 7, the data reception control section 64 transmits the packet group 7 to the data reproduction control section 65 so that the packet group 7 is sequentially reproduced.

Upon receiving a disconnection request command 8, the data reception control section 64 instructs the error analysis section 66 to reset the identification number assigned to each of data packets in the packet group 7 to zero.

A communication system 100 in accordance with the present embodiment is arranged such that, while a receiver 3 stays in a connection establishment state, a communication pathway where a connection is established is maintained even if a data reception control section 64 receives a disconnection request command 8 from a transmitter 1. In other words, while a connection between the transmitter 1 and the receiver 3 is established, the receiver 3 maintains a communication pathway between the transmitter 1 and the receiver 3 and does not carry out a reconnection between the transmitter 1 and the receiver 3 even if the receiver 3 receives a disconnection request command 8.

In this way, the transmitter 1 and the receiver 3 are changed into a connection establishment state, respectively, and transmission and reception of a connection request command 6, a packet group 7, and a disconnection request command 8 are carried out.

(Reestablishment Process)

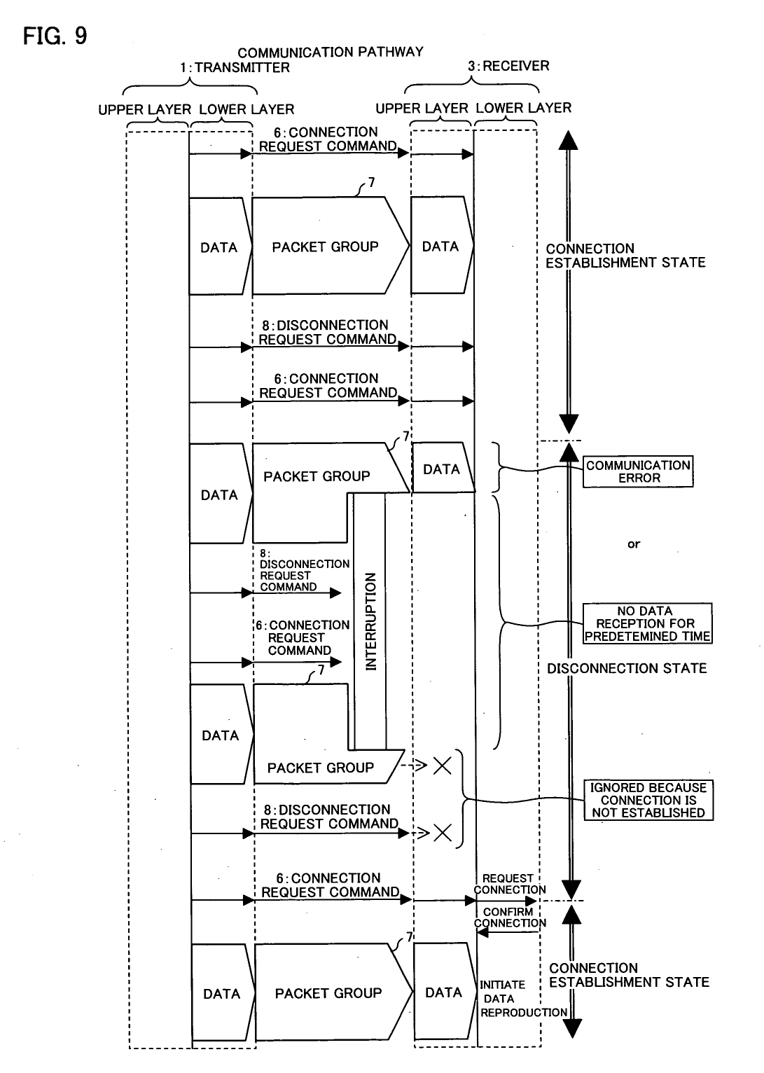

The following description deals with, with reference to FIG. 1 and FIG. 9, how a reestablishment is carried out when a communication is interrupted due to an error. FIG. 9 is an explanatory diagram illustrating how a communication reestablishment is carried out when an error occurs, in accordance with an embodiment of the present invention.

It is assumed that an error occurs while each of the transmitter 1 and the receiver 3 is in a connection establishment state, i.e., a connection is established between the transmitter 1 and the receiver 3 (see FIG. 9). FIG. 9 illustrates errors as (i) a state in which a received data packet contains an error (e.g. a packet error, a frame error or the like; such a state is hereinafter referred to as a communication error) and (ii) a state in which a data packet is not received for a certain period of time or longer (i.e. a communication interruption). In addition, the above errors also encompass an interruption of a transmission process of a connection request command 6.

As has been already described, according to the receiver 3 of the present embodiment, a data packet received by the data reception control section 64 is analyzed by the error analysis section 66. In a case where the result of the analysis indicates that an error is contained in a data packet, the error analysis section 66 determines that a communication error has occurred. Further, the error analysis section 66 determines that a communication interruption has occurred, in a case where, while the receiver 3 is in a connection establishment state, the error analysis section 66 is notified that (i) the data reception control section 64 has not received a packet group 7 for a predetermined period of time or longer, or (ii) the connection request command reception control section 62 has not received a connection request command 6 for a predetermined period of time or longer.

On determining that a communication error or a communication interruption has occurred, the error analysis section 66 notifies the communication disconnection control section 69 that an error has occurred. In response to such a notification from the error analysis section 66, the communication disconnection control section 69 instructs each of the sections as below to change the state of the receiver 3 into a disconnection state.

On determining that an error has occurred, the error analysis section 66 instructs the connection request command reception control section 62 to establish a connection in response to a subsequently supplied connection request command 6.

In response to the command, the connection request command reception control section 62, upon receiving a connection request command 6 after the state of the receiver 3 is changed into a disconnection state, transmits the connection request command 6 to the receiver connection establishment control section 67 so that the state is changed into a connection establishment state. Subsequent processes concerning the connection establishment state have been already explained in the “communication establishing process”, and therefore are not described here.

Further, in a case where a communication interruption has occurred in the process of receiving the connection request command 6, i.e., where the receiver 3 has not received the connection request command 6 for a predetermined period of time or longer, the receiver 3 is incapable of receiving the data packet group 7 (i) until the receiver 3 receives a connection request command 6 to be subsequently transmitted and (ii) for a certain period of time or longer after the communication interruption. Therefore, even in a case where a communication interruption has occurred in the process of receiving the connection request command 6, the error analysis section 66 changes the state of the receiver 3 into a disconnection state immediately, and instructs the connection request command reception control section 62 to establish a connection in response to a connection request command 6 to be subsequently received.

In a case where a communication interruption has occurred in the process of receiving the disconnection request command 8, the receiver 3 is incapable of receiving a connection request command 6 to be transmitted after the transmission of the above disconnection request command 8. It follows that the receiver 3 is incapable of receiving the packet group 7. Even in such a case, the error analysis section 66 immediately changes the state of the receiver 3 into a disconnection state, and instructs the connection request command reception control section 62 to establish a connection in response to a subsequently supplied connection request command 6.

In addition, the receiver 3 is arranged such that, even if the receiver 3 receives a disconnection request command 8 or a part of the packet group 7 while being in a disconnection state, the receiver 3 ignores them while a connection is not established.

As explained above, according to a communication system 100 of the present embodiment, a connection between a transmitter 1 and a receiver 3 is established, and then as such, whereby video data is transmitted from the transmitter 1 to the receiver 3 so as to be reproduced by streaming. As such, the communication system 100 can rapidly resume a communication and rapidly start reproduction of data. This allows the communication system 100 to be used in a communication system such as an infrared communication, in which a communication is easily blocked or interrupted.

(Communication Establishing Process and Reestablishing Process in Bi-Directional Communication)

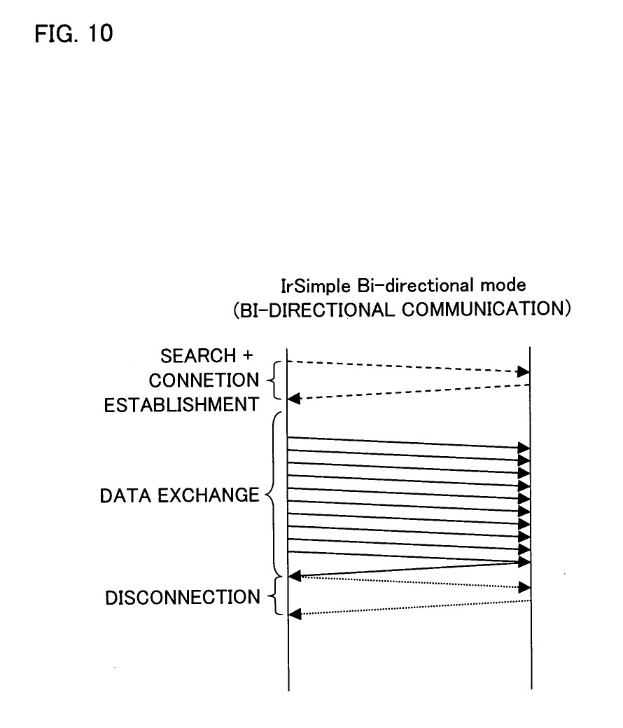

The aforementioned communication scheme between the transmitter 1 and the receiver 3 is an IrSimple uni-directional communication. Instead, it is possible to reestablish a communication similarly in an IrSimple bi-directional communication (i.e. the IrSimple Bi-directional mode) as illustrated in FIG. 10.

FIG. 10 is a sequence view illustrating one example of another communication scheme in the communication system 100 of the present embodiment.

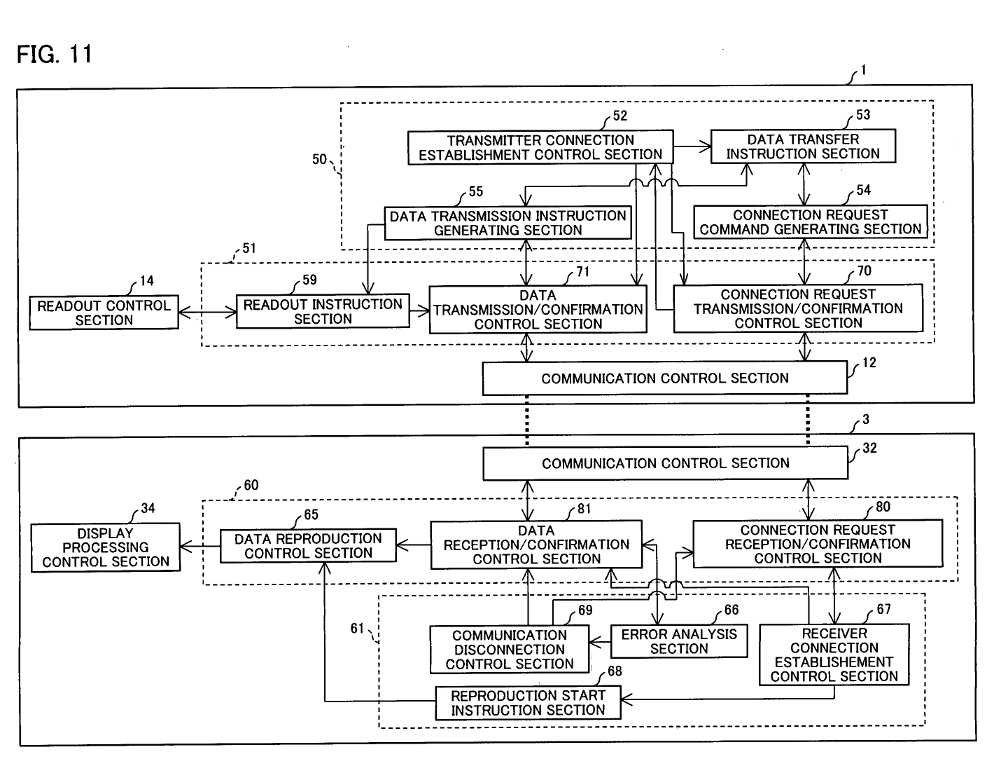

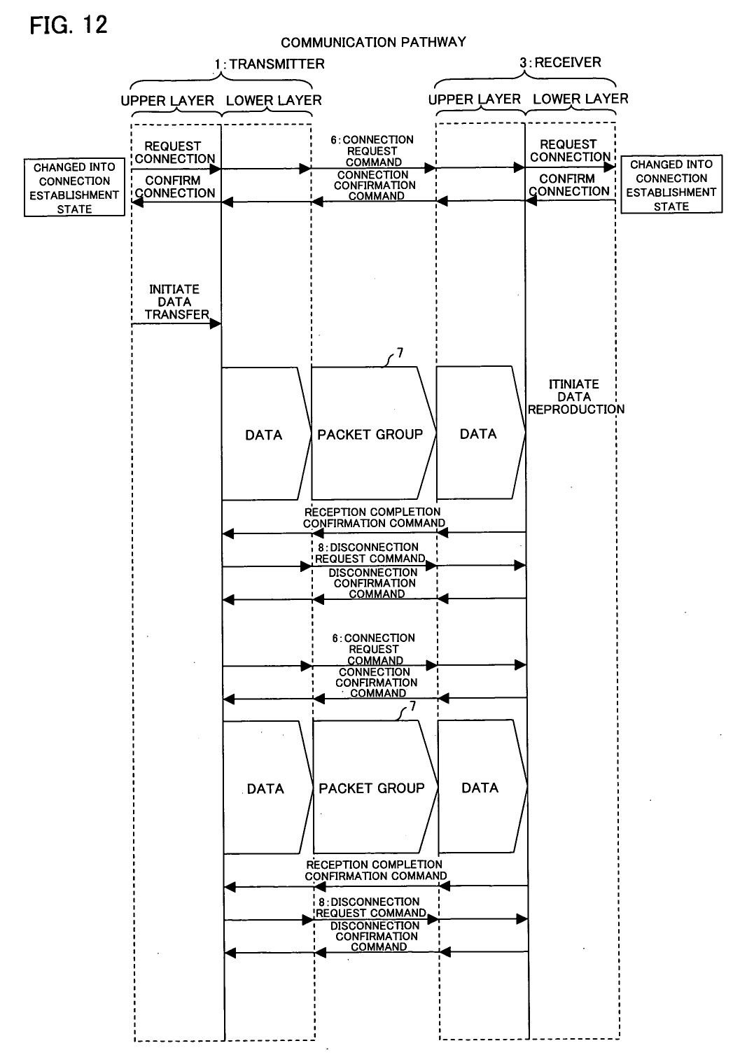

The following description deals with, with reference to FIGS. 11 and 12, an establishment of a communication between a transmitter 1 and a receiver 3 by a bi-directional information exchange. FIG. 11 is a functional block diagram illustrating another software arrangement of the transmitter 1 and the receiver 3 for data transmission and reception process, in accordance with the embodiment of the present invention. FIG. 12 is an explanatory diagram illustrating one example of how a communication is established between a transmitter and a receiver in the communication system 100 of the present embodiment.

An arrangement of each of the transmitter 1 and the receiver 3 in the bi-directional communication is different from that in the uni-directional communication, in the following respects.

The transmitter 1 includes a connection request transmission/confirmation control section 70 and a data transmission/confirmation control section 71, in place of the connection request command transmission control section 56 and the data transmission control section 58 of the transmitter lower layer processing section 51.

The receiver 3 includes a connection request reception/confirmation control section 80 and a data reception/confirmation control section 81, in place of the connection request command reception control section 62 and the data reception control section 64. The communication control section 12 and the data transmission/confirmation control section 71 realize a data transmission section and a completion information transmitting section of the present invention. The communication control section 12 and the connection request transmission/confirmation control section 70 realize a connection request information transmitting section of the present invention. Further, the communication control section 32 and the data reception/confirmation control section 81 realize a data reception section and a completion information receiving section of the present invention. The communication control section 32 and the connection request reception/confirmation control section 80 realize a connection request information receiving section of the present invention.

The transmitter 1 and the receiver 3 having such arrangements establish a communication as follows.

A connection request command causing a connection between the transmitter 1 and the receiver 3 is issued by the operation section 19, and then the input-output control section 15 of the transmitter 1 receives the connection request command. In response to the command thus received, the transmitter connection establishment control section 52 in the transmitter upper layer processing section 50 generates a connection request and transmits the connection request to the data transfer instruction section 53.

Upon receiving the connection request, the data transfer instruction section 53 instructs the connection request command generating section 54 to generate a connection request command 6. Then, the connection request command generating section 54 instructs the connection request transmission/confirmation control section 70 to transmit the connection request command 6 to the receiver 3. In response to the instruction from the connection request command generating section 54, the connection request transmission/confirmation control section 70 generates a packet which includes the connection request command 6, and instructs the communication control section 12 to transmit the packet including the connection request command 6 to the receiver 3.

The connection request command 6 thus transmitted is received by the connection request reception/confirmation control section 80 via the communication control section 32. The connection request reception/confirmation control section 80 transmits to the receiver connection establishment control section 67 a connection request which is based on the received connection request command 6. Upon receiving the connection request, the receiver connection establishment control section 67 transmits to the connection request reception/confirmation control section 80 a connection confirmation indicating that the receiver connection establishment control section 67 has recognized the connection request. In this way, when the receiver connection establishment control section 67 transmits the connection confirmation in response to the received connection request, the receiver 3 determines that a connection between the transmitter 1 and the receiver 3 has been established, and is changed into a connection establishment state.

After the receiver 3 is changed into the connection establishment state, the receiver connection establishment control section 67 controls the data reception/confirmation control section 81 and the connection request reception/confirmation control section 80 to instruct the communication control section 32 to establish a connection between the transmitter 1 and the receiver 3 and to maintain a communication pathway to the transmitter 1 so that the connection request command 6, the packet group 7 and the disconnection request command 8 can be received. Furthermore, the receiver connection establishment control section 67 instructs the reproduction start instruction section 68 to prepare a reproduction of the received packet group 7.

The connection request reception/confirmation control section 80 generates a packet of a connection confirmation command in accordance with the connection confirmation received from the receiver connection establishment control section 67, and then transmits the connection confirmation command to the transmitter 1 via the communication control section 32. The connection confirmation command thus transmitted is received by the connection request transmission/confirmation control section 70 via the communication control section 12 in the transmitter 1. A connection confirmation which is based on the connection confirmation command thus received is notified to the transmitter connection establishment control section 52.

When receiving the connection confirmation which is in conformity with the connection request command in this manner, the transmitter connection establishment control section 52 recognizes that a connection has been established between the transmitter 1 and the receiver 3, thereby changing the transmitter 1 into a connection establishment state.

After the transmitter 1 is changed into the connection establishment state, the transmitter connection establishment control section 52 controls the connection request transmission/confirmation control section 70 and the data transmission/confirmation control section 71 to instruct the communication control section 12 to establish a communication pathway so that the connection request command 6, the packet group 7 and the disconnection request command 8 are transmittable. Further, the transmitter connection establishment control section 52 instructs the data transfer instruction section 53 to prepare transmissions of the connection request command 6, the packet group 7 and the disconnection request command 8.

The data transfer instruction section 53 instructs the connection request command generating section 54 to generate the connection request command 6. The data transfer instruction section 53 then instructs the data transmission instruction generating section 55 to generate a data transmission instruction command. The data transmission instruction generating section 55 transmits the data transmission instruction command to the readout instruction section 59 in response to the instruction received from the data transfer instruction section 53. The data transmission instruction generating section 55 instructs the readout instruction section 59 to read out video data 5 from the data management and storage device 2.

Upon reading out the video data 5, the readout instruction section 59 transmits the video data 5 to the data transmission/confirmation control section 71. The data transmission/confirmation control section 71 instructs the communication control section 12 to compresses the video data 5 and transmit the video data 5 as the packet group 7 made up of a plurality of data packets.

In response to the instruction received from the data transfer instruction section 53, the data transmission instruction generating section 55 generates the disconnection request command 8 and then transmits the disconnection request command 8 to the data transmission/confirmation control section 71. The data transmission/confirmation control section 71 is arranged to transmit a packet of the disconnection request command 8, when receiving a reception completion confirmation command from the receiver 3 after the packet group 7 of the video data 5 is transmitted. However, the timing of transmitting a packet of the disconnection request command 8 is not limited to this. Alternatively, the data transmission/confirmation control section 71 may be arranged such that a disconnection request command 8 is transmitted after a response time of the receiver 3 elapsed, which response time is determined in conformity with a communication protocol or through negotiations conducted during establishing a communication pathway.

The packet group 7 and the packet of the disconnection request command 8, both transmitted from the transmitter 1, are received and processed in the receiver 3 as follows. Upon receiving the packet group 7 from the transmitter 1 via the communication control section 32, the data reception/confirmation control section 81 transmits to the transmitter 1 a packet of the reception completion confirmation command indicative of a completion of receipt of the packet group 7.

The packet group 7 is analyzed by the data reception/confirmation control section 81. The error analysis section 66 determines based on the analysis result whether or not an error has occurred in the data packets.

When the analysis result by the error analysis section 66 indicates that no error has occurred, the packet group 7 is decoded by the data reproduction control section 65, and is then supplied to the display processing control section 34.

Upon receiving the disconnection request command 8 from the transmitter 1 via the communication control section 32, the data reception/confirmation control section 81 instructs the error analysis section 66 to reset the identification number for each data packet of the packet group 7 thus received so that the identification number is reset to zero. Meanwhile, the data reception/confirmation control section 81 transmits to the transmitter 1 a disconnection confirmation command which indicates the reception of the disconnection request command 8.

As described above, a communication system 100 of the present embodiment is arranged so that: (i) when a receiver 3, in a state where a communication pathway is not established, receives a connection request command 6 from a transmitter 1, the receiver 3 issues and transmits a connection confirmation command in response to the connection request command so that a connection is established between the transmitter 1 and the receiver 3; (ii) the receiver 3 receives the packet group 7 and reproduces it in real time; and then (iii) a packet of a reception completion confirmation command after one packet group 7 has been received is transmitted to the transmitter 1 from the receiver 3.

The receiver 3 of the present embodiment is arranged so that, even in a case where an error analysis section 66 has detected an error in a received packet group 7, the receiver 3 does not transmit to the transmitter 1 a retransmission request regarding the error part of the packet data. This is because the communication system 100 of the present embodiment is arranged such that the video data 5 is transmitted from the transmitter 1 to the receiver 3 and then reproduced by streaming. This makes it impossible to request a retransmission, for subsequent use, of the part of the video data 5 which corresponds to the error part.

In a case where the receiver 3 receives a packet which includes a disconnection request command 8 from the transmitter 1 while a connection is established between the transmitter 1 and the receiver 3, a disconnection confirmation command is issued in response to the disconnection request command 8. In this case, however, the connection of the communication pathway is maintained.

Meanwhile, in the case where the receiver 3 receives a packet which includes a connection request command 6 from the transmitter 1 while the connection is established between the transmitter 1 and the receiver 3, a connection confirmation command is transmitted in response to the connection request command 6. In this case, however, no reconnection of the communication pathway is carried out.

According to the present embodiment, the transmitter 1 is arranged such that, after each of the transmitter 1 and the receiver 3 is changed into a connection establishment state, the transmitter 1 processes each of a connection confirmation command, a reception completion confirmation command and a disconnection confirmation command, received from the receiver 3 (see the following description).

A connection confirmation command from the receiver 3 is received by the connection request transmission/confirmation control section 70. The connection confirmation command is then transmitted to the data transfer instruction section 53 via the connection request command generating section 54. Upon receiving a connection request command, the data transfer instruction section 53 instructs the data transmission instruction generating section 55 to transmit a packet group 7.

A reception completion confirmation command from the receiver 3 is received by the data transmission/confirmation control section 71. The reception completion confirmation command is then transmitted to the data transfer instruction section 53 via the data transmission instruction generating section 55. Upon receiving a reception completion confirmation command, the data transfer instruction section 53 instructs the data transmission instruction generating section 55 to transmit a disconnection request command 8.

A disconnection confirmation command from the receiver 3 is received by the data transmission/confirmation control section 71. The disconnection confirmation command is then transmitted to the data transfer instruction section 53 via the data transmission instruction generating section 55. Upon receiving a disconnection confirmation command, the data transfer instruction section 53 instructs the connection request command generating section 54 to transmit a connection request command 6.

The transmitter connection establishment control section 52 is arranged so as to, (i) upon receiving a notification of a connection confirmation in response to a connection request, instruct the data transfer instruction section 53 to prepare transmission of a packet group 7 corresponding to the connection request, and (ii) upon receiving a reception completion confirmation command in response to transmission of the packet group 7, instruct the data transfer instruction section 53 to prepare a transmission of a disconnection request command 8 corresponding to the packet group 7. Note that the present embodiment is arranged so that the receiver 3 sends back within a predetermined period of time each of (i) the connection confirmation which is transmitted from the receiver 3 in response to transmission of the connection request command, (ii) the reception completion confirmation command which is transmitted from the receiver 3 in response to transmission of the packet group 7, and (iii) the disconnection confirmation command which is transmitted from the receiver 3 in response to transmission of a disconnection request command.

In a case where the above connection confirmation is not sent back within the predetermined period of time, the data transfer instruction section 53 of the transmitter 1 instructs the data transmission instruction generating section 55 to transmit a packet group 7. Accordingly, the data transmission instruction generating section 55 transmits a data transmission instruction command to the readout instruction section 59 so that the packet group 7 is transmitted.

Similarly, in a case where the above reception completion confirmation command is not sent back within the predetermined period of time, the data transfer instruction section 53 of the transmitter 1 instructs the data transmission instruction generating section 55 to generate a disconnection request command and transmit the disconnection request command to the data transmission/confirmation control section 71 so that the disconnection request command is transmitted to the receiver 3.

Moreover, in a case where the above disconnection confirmation command is not sent back within the predetermined period of time, the data transfer instruction section 53 of the transmitter 1 instructs the connection request command generating section 54 to generate a connection request command 6 and transmit the connection request command 6 to the connection request transmission/confirmation control section 70 so that the connection request command 6 is transmitted to the receiver 3.

As discussed above, a communication system 100 of the present embodiment can establish a connection between the transmitter 1 and the receiver 3 even in a case of employing an IrSimple bi-directional communication as a communication scheme.

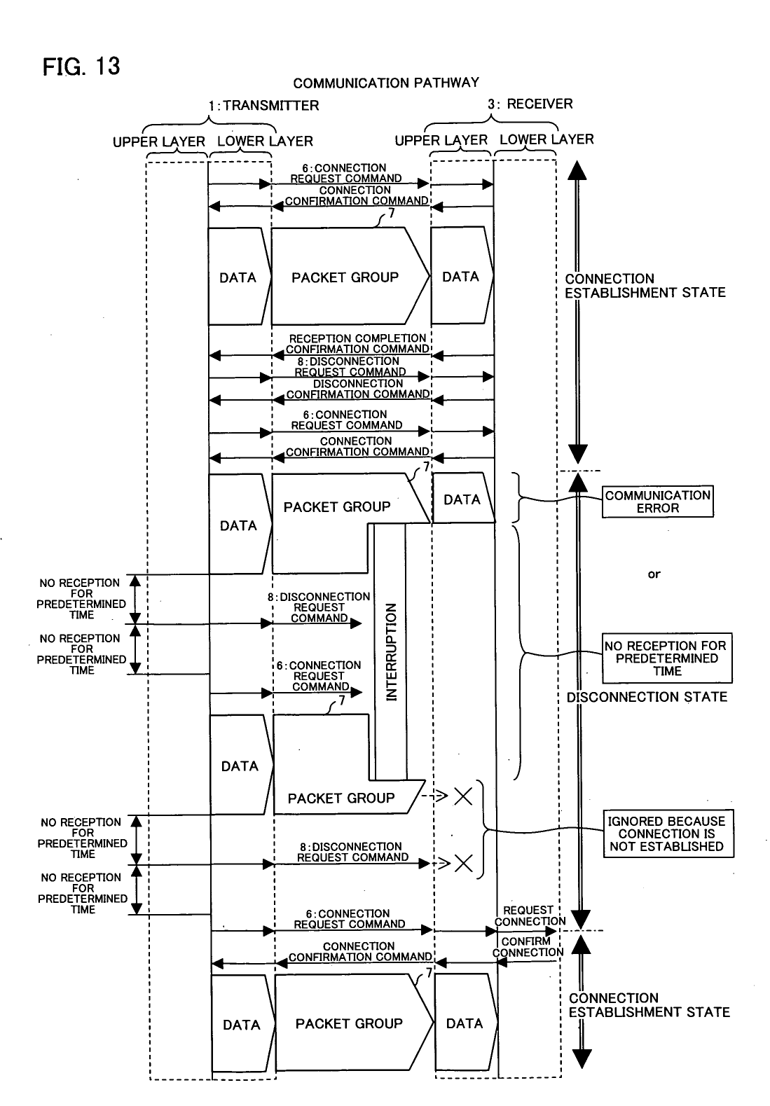

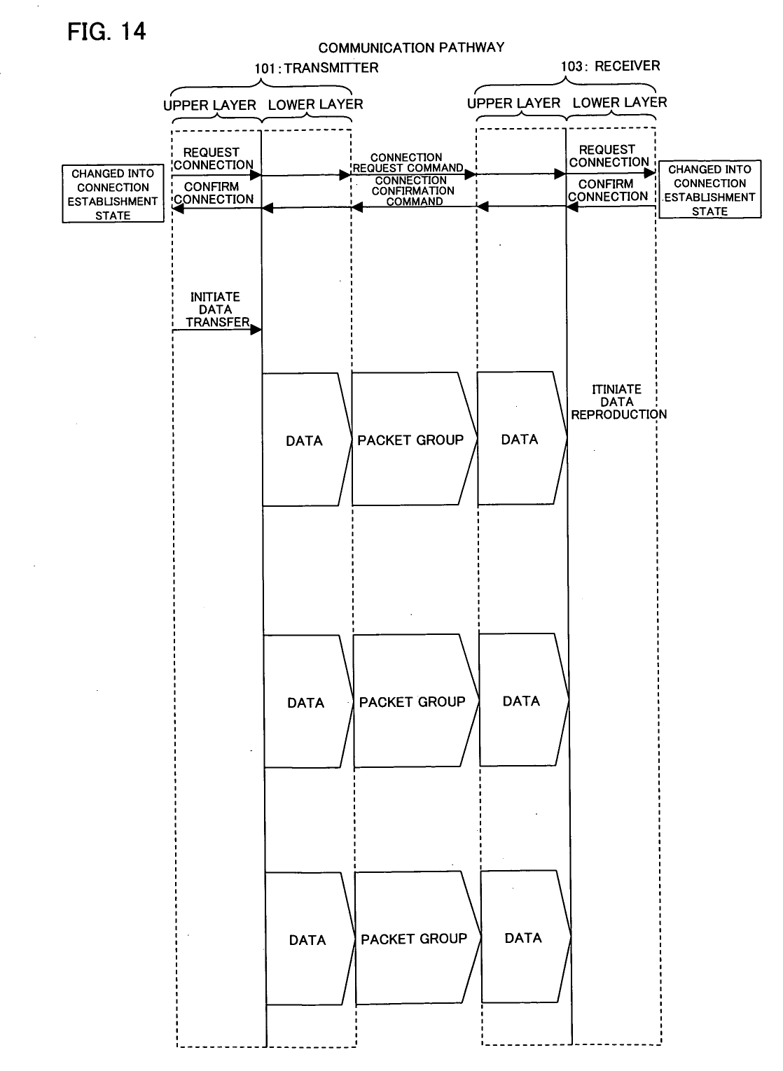

As illustrated in FIG. 13, the present embodiment is arranged so that, in a case where a communication error or an error caused by interruption has occurred, the communication system 100 is changed into a disconnection state from a connection establishment state, and the communication system 100 is changed from a connection establishment state into a disconnection state again when the receiver 3 receives another connection request command 6. FIG. 13 is an explanatory diagram illustrating how a communication is reestablished when an error occurs, in accordance with the embodiment of the present invention.

When the error analysis section 66 analyses a data packet received by the data reception/confirmation control section 81 and determines that an error has occurred, the error analysis section 66 notifies the communication disconnection control section 69 of its determination result. In response to the notification from the error analysis section 66, the communication disconnection control section 69 changes the state of the receiver 3 into a disconnection state, and then instructs each of the sections as follows.

When the error analysis section 66 determines that an error has occurred, the communication disconnection control section 69 instructs the connection request reception/confirmation control section 80 to establish a connection in response to a subsequently supplied connection request command 6.

In response to the instruction, the connection request reception/confirmation control section 80, upon receiving the connection request command 6 after the receiver 3 is changed into a disconnection state, transmits the connection request command 6 to the receiver connection establishment control section 67 so that the receiver 3 is changed into a connection establishment state. The subsequent processes concerning the connection establishment state have been explained in the aforementioned “communication establishing process”, and therefore are not described here.

The communication system 100 of the present embodiment is arranged so as to, when the error analysis section 66 determines that an error has occurred, change the receiver 3 into a disconnection state, and then so as to reestablish a connection between the transmitter 1 and the receiver 3 in response to a subsequently supplied connection request command 6. The present embodiment, however, is not limited to this. Alternatively, the communication system 100 may be arranged so as to, in a case where an error is recoverable, continue to receive the packet group 7 instead of changing the receiver 3 into a disconnection state.

The present embodiment may be arranged so that, when a reconnection is established between the transmitter 1 and the receiver 3, a notification of such a reconnection is provided to a user as a part of the operation of the receiver 3 (e.g. such a notification is displayed on a screen of the display section 4).

Although the communication system 100 of the present embodiment is arranged so as to establish a connection between the transmitter 1 and the receiver 3 by an infrared communication which uses an IrSimple as a communication protocol, a communication scheme in the present embodiment is not limited to this.

Note however that the adoption of the IrSimple allows a connection between devices with use of one packet (i.e. a connection request command 6) or one pair of packets (i.e. a connection request command 6 and a connection confirmation command). As such, it is possible to advantageously shorten the time required to establish a connection between the transmitter 1 and the receiver 3, in comparison with a normal infrared communication protocol. Since a communication system 100 of the present embodiment aims to rapidly establish a reconnection after a disconnection, the effect is significant particularly in the case of using an IrSimple infrared communication.

Although the present embodiment deals with a case where an infrared radiation is adopted as a transmission medium in the communication system 100 of the present embodiment, a transmission medium of the present embodiment is not limited to this. Alternatively, a directional wireless communication which uses a millimeter wave, or an optical space communication which uses visible light or the like.

Although the present embodiment deals with a case where video data is transmitted in a communication system 100 of the present embodiment, data for transmission of the present embodiment is not limited to this, provided that the data, such as document data, image data, or music data, is receivable and usable in the receiver 3.

As described above, each of the transmitter 1 and the receiver 3 includes (i) the CPU (Central Processing Unit) that executes commands from a control program causing each of the functions illustrated as the functional blocks to be realized, (ii) storage mediums such as the ROM (Read Only Memory) in which the program is stored and the RAM (Random Access Memory) on which the program is loaded.

Each of the above functions is achievable (i) by supplying to each of the transmitter 1 and the receiver 3 a recording medium in which computer-readable program codes (an executable program, an intermediate code program and a source program) of a control program is stored, which control program is software for realizing the functions, and (ii) by causing a computer (or a CPU) to read out and execute the program codes stored in the recording medium.

Recording media which are useable as the recording medium encompasses, (i) a tape medium such as a magnetic tape, (ii) a disc medium including a magnetic disc and an optical disc, (iii) a card medium such as an IC card (including a memory card) or an optical card, or (iv) a semiconductor memory such as a masked ROM, an EPROM, an EEPROM or a flash ROM.

Further, when each of the transmitter 1 and the receiver 3 is arranged so as to be connectable to a communication network, the program codes can be provided via the communication network. Examples of such a communication network encompass the Internet, an intranet, an extranet, a LAN, an ISDN, a VAN, a CATV communication network, a virtual private network, a telephone network, a mobile communication network, and a satellite communication network. In addition, the transmission medium of the communication network is not particularly limited; for example, (i) cable communication with use of an IEEE1394, a USB, a power line carrier, a cable TV line, a telephone line or an ADSL, or (ii) wireless communication with use of an infrared radiation of the IrDA standard, a Bluetooth (registered trademark), an 802.11 wireless network, an HDR, a mobile phone network, a satellite connection or a digital terrestrial network. Additionally, the present invention is achievable by use of a computer data signal embodied in a carrier wave, which signal is formed by electronic transmission of the program codes.

As described above, a receiver of the present invention is a receiver which establishes a communication, by a directional wireless communication, between the receiver and a transmitter that transmits data, and which receives the data from the transmitter, the transmitter transmitting connection request information for requesting a connection between the transmitter and the receiver to the receiver at a predetermined period, and the transmitter transmitting data related to the connection request information to the receiver after transmitting the connection request information, said receiver comprising: a communication device for establishing a communication between the transmitter and the receiver, and for releasing the communication thus established; a release control section for carrying out a control with respect to the communication device to release the communication thus established between the transmitter and the receiver; and an establishment control section which controls the communication device so that a connection between the transmitter and the receiver is established in accordance with the connection request information, in a case where the connection request information is received from the transmitter while the communication established between the transmitter and the receiver is released in accordance with the control with respect to the communication device which control is carried out by the release control section.

Examples of such a directional wireless communication encompass an infrared communication, an optical space communication such as a visible light communication, and a millimeter wave communication.

With the arrangement, since the establishment control section is provided, it is possible to control the communication device to establish a connection between the transmitter and the receiver in accordance with the connection request information transmitted from the transmitter at a predetermined period while the receiver is in a state where a communication established between the transmitter and the receiver has been released. From this reason, for example, even in a case where a communication established between the transmitter and the receiver has been released, the receiver can establish a connection in accordance with the connection request information to be received from the transmitter at the predetermined period. This allows a connection between the transmitter and the receiver to be established more rapidly than an arrangement in which information is exchanged between a transmitter and a receiver so that a connection established between the transmitter and the receiver is released and another connection between the transmitter and the receiver is established.

It is thus possible for a receiver of the present invention to promptly reestablish a connection between a transmitter and a receiver. As such, even in a case where data is reproduced by streaming with the use of a communication scheme such as a directional wireless communication in which a communication error such as an interruption of the communication frequently occurs, it is possible to return to a reproducing state in a short period of time. This allows a reproduction to be promptly resumed even when image and the like are not continuous during the watching and listening.

As such, a receiver of the present invention has at least an effect of realizing a natural reproduction of streaming data with the use of a directional wireless communication.

The receiver having the above arrangement may further include an error determination section for determining whether or not an error occurs in the communication between the transmitter and the receiver, wherein, when the error determination section determines that an error has occurred, the release control section controls the communication device so that the communication established between the transmitter and the receiver is released.

The receiver having the above arrangement may further include a data reception section for receiving the data, wherein, when the data received by the data reception section includes an error, the error determination section determines that an error has occurred in the communication between the transmitter and the receiver.

The receiver having the above arrangement may further include a completion information receiving section for receiving completion information indicating that the transmitter has completed transmission of the data related to the connection request information, wherein the error determination section identifies each of the data received by the data reception section in accordance with the completion information received by the completion information receiving section, checks whether each of the data includes an error so as to determine whether or not an error occurs.

The receiver having the above arrangement may be arranged such that, when the data reception section has received no data for a period of time defined as the predetermined period, the error determination section determines that an error has occurred in the communication between the transmitter and the receiver.

The receiver having the above arrangement may further include a connection request information receiving section for receiving the connection request information, wherein, when the connection request information receiving section has received no connection request information for a period of time defined as the predetermined period, the error determination section determines that an error has occurred in the communication between the transmitter and the receiver.

With the arrangement, since the receiver includes the error determination section, it is possible to control the communication device to promptly release a connection established between the transmitter and the receiver when the error determination section determines that an error has occurred in a communication between the transmitter and the receiver. In this way, in a case where an error occurs in a communication, it is possible to immediately release the connection established between the transmitter and the receiver, thereby resulting in that a reestablishment of a connection between the transmitter and the receiver can be carried out immediately.

Such an error which occurs in a communication may be, for example, a state where received data includes an error, or a state where the receiver has received no data or no connection request information for a period of time defined as the predetermined period, that is, a state where a connection between the transmitter and the receiver is interrupted.

The receiver may be arranged such that each of the data received is identified and determined in accordance with the completion information whether each of the data includes an error. With the arrangement, it is possible to check a status, in which a part of different data is additionally received, as an error. As such, it is possible to improve integrity of data to be received.

The receiver having the above arrangement may be arranged such that the establishment control section controls the communication device so that a connection between the transmitter and the receiver is established by generating a confirmation signal which is in accordance with the connection request information, in a case where the connection request information is received from the transmitter while the communication established between the transmitter and the receiver is released in accordance with the control with respect to the communication device which control is carried out by the release control section.

The receiver having the above arrangement may be arranged such that the establishment control section controls the communication device so that a connection between the transmitter and the receiver is established by supplying to the transmitter a confirmation signal which is in accordance with the connection request information, in a case where the connection request information is received from the transmitter while the communication established between the transmitter and the receiver is released in accordance with the control with respect to the communication which control is carried out by the release control section.

In a case, for example, where a transmitter and a receiver are arranged such that data is only uni-directionally transmitted from the transmitter to the receiver, the receiver cannot supply to the transmitter information for notifying a confirmation of receiving connection request information. From this reason, the receiver generates a confirmation signal within the receiver itself. This allows the receiver to recognize that a connection between the transmitter and the receiver is established, and the confirmation signal generated by the receiver triggers a subsequent control of the receiver.

On the other hand, in a case where a transmitter and a receiver are arranged so as to transmit data and/or the like to each other, the receiver can transmit to the transmitter information for notifying a confirmation of receiving connection request information. From this reason, the transmitter transmits its confirmation signal to the receiver, and the receiver recognizes that a connection between the transmitter and the receiver is established. The reception of the confirmation signal by the receiver triggers a subsequent control of the receiver.

Furthermore, a transmitter of the present invention is arranged so that a transmitter establishes a communication between the transmitter and a receiver by a directional wireless communication, said receiver including: a communication device for establishing a communication between the transmitter that transmits data and the receiver, and for releasing the communication thus established; a release control section for carrying out a control with respect to the communication device to release the communication thus established between the transmitter and the receiver; and an establishment control section which controls the communication device so that a connection is established between the transmitter and the receiver, wherein the establishment control section controls the communication device so that a connection between the transmitter and the receiver is established in accordance with connection request information for requesting a connection between the transmitter and the receiver, in a case where the connection request information is received from the transmitter while the communication established between the transmitter and the receiver is released in accordance with the control with respect to the communication device which control is carried out by the release control section, said transmitter comprising: a connection request information transmitting section for transmitting the connection request information at a predetermined period; and a data transmission section for transmitting the data related to the connection request information after transmitting the connection request information.

With the arrangement, because the transmitter includes a connection request information transmitting section, even in a case, for example, where a connection established between the transmitter and the receiver has been released, the receiver can control the communication device so that a connection between the transmitter and the receiver is established in accordance with connection request information transmitted from the transmitter at a predetermined period. This allows a connection between the transmitter and the receiver to be established more rapidly than an arrangement an arrangement in which information is exchanged between a transmitter and a receiver so that a connection established between the transmitter and the receiver is released and another connection between the transmitter and the receiver is established.

It is thus possible for a transmitter of the present invention to immediately reestablish a connection between the transmitter and the receiver. As such, even in a case where data is reproduced by streaming with the use of a communication scheme such as a directional wireless communication in which a communication error such as an interruption of the communication frequently occurs, it is possible to return to a reproducing state in a short period of time. This allows a reproduction to be promptly resumed even when image and the like are not continuous during the watching and listening.

As such, a transmitter of the present invention has at least an effect of realizing a natural reproduction of streaming data with the use of a directional wireless communication.

The transmitter having the above arrangement may further include a completion information transmitting section for transmitting completion information indicative of completion of data that is transmitted from the transmitter in response to the connection request information The transmitter having the above arrangement may be arranged such that the data to be transmitted to the receiver by the data transmission section is one or more packet data in which a certain amount of streaming data is stored, and a different identification number is assigned to each of said one or more packet data.

According to the arrangement, since the transmitter further includes a completion information transmitting section, the transmitter can transmit completion information for each data to be transmitted to the receiver. From this reason, the receiver can recognize as an error a status, for example, in which a part of data different from data which is in accordance with connection request information is additionally received. As such, it is possible to improve integrity of data to be received.

Especially, in a case where data to be transmitted by the data transmission section to the receiver is one or more packet data containing a certain amount of streaming data, and a different identification number is assigned to each of the one of more packet data, it is also possible to check whether or not each of the data packets is properly transmitted based on the identification numbers. As such, it is possible to further improve integrity of data to be received.

The transmitter having the above arrangement may be arranged such that when the transmitter transmits the data to the receiver, the receiver sends back, within a predetermined period of time, reception confirmation information indicating that the data transmitted by the transmitter has been received by the receiver, and the data transmission section transmits data to be subsequently transmitted, when the transmitter has received the reception confirmation information or when the transmitter has received no reception confirmation information after elapse of a predetermined period of time from transmission of the data.

According to the arrangement, when the transmitter has received the reception confirmation information or when a predetermined time or longer elapsed after transmission of the data, it is possible to transmit data to be subsequently transmitted. In a case where subsequent data is transmitted after confirmation information has been received, it is possible to make sure that the data transmitted has been received by the receiver and then transmit the subsequent data. This makes it possible to surely transmit data continuously.

On the other hand, the transmitter is arranged so as to transmit subsequent data even in a case where the transmitter has received no confirmation information for a predetermined time or longer. It is thus possible to transmit data continuously. On this account, in a case where, for example, in an arrangement where data is reproduce by streaming, a confirmation information has not been able to be received but a connection between a transmitter and a receiver is still established, it is possible to continuously reproduce data without interruption.

A communication system of the present invention includes: a transmitter which transmits data; and a receiver which establishes a communication, by a directional wireless communication, between the receiver and the transmitter, and which receives the data from the transmitter, the transmitter transmitting connection request information for requesting a connection between the transmitter and the receiver to the receiver at a predetermined period, and the transmitter transmitting data related to the connection request information to the receiver after transmitting the connection request information, said receiver including: a communication device for establishing a communication between the transmitter and the receiver, and for releasing the communication thus established; a release control section for carrying out a control with respect to the communication device to release the communication thus established between the transmitter and the receiver; and an establishment control section which controls the communication device so that a connection between the transmitter and the receiver is established in accordance with the connection request information, in a case where the connection request information is received from the transmitter while the communication established between the transmitter and the receiver is released in accordance with the control with respect to the communication device which control is carried out by the release control section, said transmitter including: a connection request information transmitting section for transmitting connection request information for requesting a connection at a predetermined period; and a data transmission section for transmitting the data related to the connection request information after transmitting the connection request information.

According to the arrangement, because the transmitter includes a connection request information transmitting section and the receiver includes an establishment control section, even if, for example, a communication established between the transmitter and the receiver has been released, the receiver can establish a connection between the receiver and the transmitter in accordance with the connection request information to be received from the transmitter at a predetermined period. This allows the communication system to establish a connection more rapidly than an arrangement in which information is exchanged between a transmitter and a receiver so that a connection established between the transmitter and the receiver is released and another connection between the transmitter and the receiver is established.

The communication system of the present invention can immediately reestablish a connection between the receiver and the transmitter, as such. This makes it possible to recover a reproduction at short times even in a case where streaming data is reproduced with the use of a communication scheme such as a directional wireless communication in which a communication error such as an interruption of a communication often occurs. As a result, this makes it possible to restrain such an undesirable situation that video data and the like is interrupted during watching and listening the image and the like.

Consequently, a communication system of the present invention has an effect to realize a natural reproduction of streaming data with the use of a directional wireless communication.

The communication system having the above arrangement may be arranged such that the communication between the receiver and the transmitter is carried out by use of an IrSimple, which is an infrared communication protocol. The IrSimple is a scheme in which a packet having both of a function of searching a destination device and a function as a command having necessary parameters for connection is outputted when a communication starts so that a communication is established, and then a predetermined number of data are transmitted. This allows largely shortening time for establishing a communication compared with a case of using conventional infrared communication.

Accordingly, it is thus possible for the communication system of the present invention to further promptly reestablish a connection between a receiver and a transmitter.

Moreover, a method of the present invention for controlling a receiver is a method for controlling a receiver which establishes a communication, by a directional wireless communication, between the receiver and a transmitter that transmits data, and which receives the data from the transmitter, the transmitter transmitting connection request information for requesting a connection between the transmitter and the receiver to the receiver at a predetermined period, and the transmitter transmitting data related to the connection request information to the receiver after transmitting the connection request information, said method comprising the steps of: (i) releasing a communication established between the transmitter and the receiver; and (ii) causing a connection between the transmitter and the receiver to be established in accordance with the connection request information, in a case where the connection request information is received from the transmitter while the communication established between the transmitter and the receiver is released in accordance with the step (i).

According to the method, in a case where connection request information transmitted from the transmitter at a predetermined time is received while a communication between the transmitter and the receiver is released by the step of releasing a communication established between the transmitter and the receiver, it is possible to establish a connection between the transmitter and the receiver in accordance with the connection request information.

From this reason, for example, even in a case where a communication established between the transmitter and the receiver has been released, the receiver can establish a connection in accordance with the connection request information to be received from the transmitter at the predetermined period. This allows a connection between the transmitter and the receiver to be established more rapidly than an arrangement in which information is exchanged between a transmitter and a receiver so that a connection established between the transmitter and the receiver is released and another connection between the transmitter and the receiver is established.

It is thus possible for a method of the present invention for controlling a receiver to promptly reestablish a connection between a transmitter and a receiver. As such, even in a case where data is reproduced by streaming with the use of a communication scheme such as a directional wireless communication in which a communication error such as an interruption of the communication frequently occurs, it is possible to return to a reproducing state in a short period of time. This allows a reproduction to be promptly resumed even when image and the like are not continuous during the watching and listening.

Consequently, the method of the present invention for controlling a receiver has an effect to realize a natural reproduction of streaming data with the use of a directional wireless communication.

Furthermore, in order to achieve the above object, a communication method of the present invention is a communication method for transmitting data from a transmitter to a receiver via a directional wireless communication, the communication method comprising the steps of: transmitting connection request information, for requesting a connection between the transmitter and the receiver, from the transmitter to the receiver at a predetermined period; transmitting the data related to the connection request information from the transmitter to the receiver after transmitting the connection request information; and causing a connection between the transmitter and the receiver to be established in accordance with the connection request information so that the data transmitted from the transmitter is received, in a case where the connection request information is received from the transmitter while the communication between the transmitter and the receiver is released.

As such, the method includes the steps of transmitting connection request information and data from the transmitter to the receiver at a predetermined period, and further includes the step of causing a connection between the transmitter and the receiver to be established in accordance with the connection request information so that the data transmitted from the transmitter is received, in a case where the connection request information is received from the transmitter while the communication established between the transmitter and the receiver is released. With the arrangement, for example, even in a case where a communication established between a transmitter and a receiver has been released, the receiver can establish a connection between the transmitter and the receiver in accordance with connection request information transmitted from the transmitter at a predetermined period. This allows a communication system of the present invention to establish a connection more promptly than an arrangement in which information is exchanged between a transmitter and a receiver so that a connection established between the transmitter and the receiver is released and another connection between the transmitter and the receiver is established.

It is thus possible for the communication system of the present invention to promptly reestablish a connection between a receiver and a transmitter As such, even in a case where data is reproduced by streaming with the use of a communication scheme such as a directional wireless communication in which a communication error such as an interruption of the communication frequently occurs, it is possible to return to a reproducing state in a short period of time. This makes it possible to restrain such an undesirable status that image and the like are not continuous during watching and listening.

Consequently, the communication system of the present invention has an effect to realize a natural reproduction of streaming data with the use of a directional wireless communication.

The receiver may be realized by a computer. In such a case, a program for controlling a receiver which program causes a computer to function as the respective sections of the receiver so that the receiver is realized in the computer, and a computer-readable storage medium which stores the program are also encompassed in a scope of the present invention.

### INDUSTRIAL APPLICABILITY

As described above, a communication scheme, a transmitter and a receiver of the present invention are applicable to a streaming communication made through a communication pathway whose communication connection tends to be interrupted, and are particularly effective in an optical space communication. Further, the communication scheme, the transmitter and the receiver of the present invention are applicable to mobile phones, which carry out a streaming communication, digital cameras, televisions, projectors and recording devices such as DVD recorders or HDD recorders.

Lastly, a transmitter and a receiver in the communication system 100 of the present embodiment can be described as having the following arrangement. Further, a communication method of the communication system 100 can be described as including the following process.

A communication method of the communication system 100 in accordance with the present embodiment is for use in a streaming communication in which continuous data such as moving video data and/or audio data is communicated while the continuous data is reproduced in real time. According to the communication method, in a communication form in which a communication packet including information is uni-directionally communicated, first through third packets are set so that (i) the first packet, for establishing a communication pathway, comes before the second packet(s) in which a predetermined amount of streaming data is stored and (ii) the third packet, for disconnecting the communication pathway, comes after the second packet(s), and so that the transmission of the first packet, the second packet(s) and the third packet is repeated as one unit.

A transmitter 1 of the present embodiment, which uses the communication method, is arranged so as to (i) transmit the first packet for establishing a communication pathway in a state where no communication pathway is established, (ii) to be changed into a state where a communication pathway is established, and then (iii) transmit the first packet for establishing a communication pathway or the third packet for disconnecting the communication while remaining in a state where the communication pathway is established until a completion process is performed as instructed via a user interface or until the transmission of streaming data is completed.

A receiver 3 of the present embodiment, which uses the above communication method, is arrange so as to (i) be changed into a state where a communication pathway is established, upon receiving the first packet for establishing a communication pathway in a state where no communication pathway is established and (ii) be changed into a state where a communication pathway is disconnected, (i) in a case where a completion process is performed as instructed via a user interface, (ii) in a case where a communication error is detected during reception of data packets by (a) an error detection mechanism in a packet or (b) detection of a missing packet, or (iii) in a case where no packet has been received for a predetermined period of time or longer, without being changed into a state where a communication pathway is disconnected even if the receiver receives the third packet for disconnecting the communication pathway.

With the arrangement, even if a communication pathway is interrupted, another communication pathway is ensured by a subsequent packet for establishing a communication pathway. This makes it possible to resume a reproduction of the streaming data.

The communication method of the communication system 100 of the present embodiment is a streaming communication, in which continuous data such as moving video data and/or audio data is communicated while the continuous data is reproduced in real time. According to the communication method, in a communication form in which a communication packet including information is bi-directionally communicated, first through third packets are exchanged so that (i) the first packet, for establishing a communication pathway is exchanged before the second packet(s), in which a predetermined amount of streaming data is stored, is exchanged and (ii) the third packet for disconnecting the communication pathway is exchanged after the second packet(s) is(are) exchanged, and so that the exchanging of the first packet, the second packet(s) and the third packet is repeated as one unit.

A transmitter 1 of the present embodiment, which uses the communication method, may be arranged so as to (i) transmit the first packet for establishing a communication pathway in a state where no communication pathway is established, (ii) to be changed into a state where a communication pathway is established, after receiving a successful response with regard to the first packet, and then (iii) exchange the first packet for establishing a communication pathway or the third packet for disconnecting the communication while remaining in a state where the communication pathway is established until a completion process is performed as instructed via a user interface or until the transmission of streaming data is completed.

A receiver 3 of the present embodiment, which uses the above communication method, may be arrange so as to (i) transmit a packet indicating that a communication pathway for the first packet has been established, and be changed into a state where a communication pathway is established, upon receiving the first packet for establishing a communication pathway in a state where no communication pathway is established and (ii) be changed into a state where a communication pathway is disconnected, (i) in a case where a completion process is performed as instructed via a user interface, (ii) in a case where a communication error is detected during reception of data packets by (a) an error detection mechanism in a packet or (b) detection of a missing packet, or (iii) in a case where no packet has been received for a predetermined period of time or longer, without being changed into a state where a communication pathway is disconnected even if the receiver receives the third packet for disconnecting the communication pathway. With the arrangement, even if a communication pathway is interrupted, another communication pathway is ensured by a subsequent packet for establishing a communication pathway. This makes it possible to resume a reproduction of the streaming data.

It is preferable that, in the transmitter 1, in a case where the first packet, for establishing a communication pathway, includes a plurality of packet data which have identification numbers concerning communication pathways, respectively, each of the identification numbers be a sequential number, i.e., the identification numbers differ from each other.

With the arrangement, it is possible to avoid that unintended data is received, in a case where a sequential number is assigned to each of the plurality of packet data in which streaming data is stored, when an interruption occurs during receiving of the packet data in a receiver and then such an interruption is released in a middle of a plurality of packet data in which a subsequent streaming data is stored, and when receiving of packet data happens to resume packet data from an identification number following the identification number of the packet data which was interrupted. This is because the identification numbers of the packet data are different from each other.

The present invention adopts an IrSimple, which uses light and is an infrared communication protocol. The IrSimple protocol allows a communication pathway (i) to be established in approximately 0.1 to 0.2 seconds and (ii) to be disconnected in 0.01 second or less. This makes it possible to communicate without greatly reducing an effective communication frequency band even when connection and disconnection of a communication pathway are performed frequently, as described above, on a communication channel.

According to a communication system of the present embodiment, in which the IrSimple protocol is adopted, a connection request command 6 is transmitted from a transmitter 1 to a receiver 3 at a predetermined interval, and data transmitted after each of the connection request commands 6 is transmitted. The communication system is arguably advantageous in the following respects, in comparison with a conventional communication system adopting an IrSimple protocol.

In a case where a uni-directional communication is carried out based on the IrSimple protocol in a conventional communication system, the transmitter 1 can not detect an interruption occurred in a communication between the transmitter 1 and the receiver 3. Therefore, once interrupted, the communication remains interrupted. On the other hand, according to a communication system 100 of the present embodiment, even when an interruption of a communication occurs between a transmitter 1 and a receiver 3 is interrupted, it is possible to reestablish a connection between the transmitter 1 and the receiver 3 based on a connection request command 6 to be transmitted after the interruption.

In a case where a bi-directional communication is carried out based on the IrSimple protocol in a conventional communication system, data which has passed a timestamp is transmitted again, because such a communication system is arranged so as to retransmit missing data due to a communication interruption. During retransmitting of the missing data in such a conventional communication system, it takes an amount of time (Link Disconnect) to wait for a retransmission request from a destination device (the receiver 3) so that whether or not the connection between the transmitter 1 and the destination device (the receiver 3) has been disconnected due to some reasons. The time required for the “Link Disconnect” falls within a range from 1 second to 40 seconds.

In contrast, a communication system 100 of the present embodiment, without retransmitting of missing data, allows establishment of a connection between a transmitter 1 and a receiver 3 in response to a connection request command 6 which is transmitted after a communication interruption. The connection request command 6 is transmitted at a period of approximately 500 msec to 1 second. As such, it is possible to establish a connection between the transmitter 1 and the receiver 3 within a period of time of 500 msec to 1 second. In other words, a communication system 100 of the present embodiment, even in a case where a communication is carried based on an IrSimple protocol, can establish a reconnection between a transmitter 1 and a receiver 3 in a more rapidly than a conventional communication system.

The present invention is not limited to the description of the embodiments above, but may be altered by a skilled person within the scope of the claims. An embodiment based on a proper combination of technical means disclosed in different embodiments is encompassed in the technical scope of the present invention.

What is claimed is:

1. A receiver which establishes a communication, by a directional wireless communication, between the receiver and a transmitter that transmits data, and which receives the data from the transmitter,
the transmitter transmitting connection request information for requesting a connection between the transmitter and the receiver to the receiver at a predetermined period, and the transmitter transmitting data related to the connection request information to the receiver after transmitting the connection request information,
said receiver comprising:
a communication device for establishing a communication between the transmitter and the receiver, and for releasing the communication thus established;
a release control section for carrying out a control with respect to the communication device to release the communication thus established between the transmitter and the receiver; and
an establishment control section which controls the communication device so that a connection between the transmitter and the receiver is established in accordance with the connection request information, in a case where the connection request information is received from the transmitter while the communication established between the transmitter and the receiver is released in accordance with the control with respect to the communication device which control is carried out by the release control section.

2. The receiver as set forth in claim 1, further comprising:
an error determination section for determining whether or not an error occurs in the communication between the transmitter and the receiver,
wherein, when the error determination section determines that an error has occurred, the release control section controls the communication device so that the communication established between the transmitter and the receiver is released.

3. The receiver as set forth in claim 2, further comprising:
a data reception section for receiving the data,
wherein, when the data received by the data reception section includes an error, the error determination section determines that an error has occurred in the communication between the transmitter and the receiver.

4. The receiver as set forth in claim 3, further comprising:
a completion information receiving section for receiving completion information indicating that the transmitter has completed transmission of the data related to the connection request information,
wherein the error determination section identifies each of the data received by the data reception section in accordance with the completion information received by the completion information receiving section, checks whether each of the data includes an error so as to determine whether or not an error occurs.

5. The receiver as set forth in claim 2,
wherein, when the data reception section has received no data for a period of time defined as the predetermined period, the error determination section determines that an error has occurred in the communication between the transmitter and the receiver.

6. The receiver as set forth in claim 2, further comprising:
a connection request information receiving section for receiving the connection request information,
wherein, when the connection request information receiving section has received no connection request information for a period of time defined as the predetermined period, the error determination section determines that an error has occurred in the communication between the transmitter and the receiver.

7. The receiver as set forth in claim 1, wherein:
the establishment control section controls the communication device so that a connection between the transmitter and the receiver is established by generating a confirmation signal which is in accordance with the connection request information, in a case where the connection request information is received from the transmitter while the communication established between the transmitter and the receiver is released in accordance with the control with respect to the communication device which control is carried out by the release control section.

8. The receiver as set forth in claim 1, wherein:
the establishment control section controls the communication device so that a connection between the transmitter and the receiver is established by supplying to the transmitter a confirmation signal which is in accordance with the connection request information, in a case where the connection request information is received from the transmitter while the communication established between the transmitter and the receiver is released in accordance with the control with respect to the communication device which control is carried out by the release control section.

9. A transmitter which establishes a communication between the transmitter and a receiver by a directional wireless communication,
said receiver including:
a communication device for establishing a communication between the transmitter that transmits data and the receiver, and for releasing the communication thus established;
a release control section for carrying out a control with respect to the communication device to release the communication thus established between the transmitter and the receiver; and
an establishment control section which controls the communication device so that a connection is established between the transmitter and the receiver,
wherein the establishment control section controls the communication device so that a connection between the transmitter and the receiver is established in accordance with connection request information for requesting a connection between the transmitter and the receiver, in a case where the connection request information is received from the transmitter while the communication established between the transmitter and the receiver is released in accordance with the control with respect to the communication device which control is carried out by the release control section,
said transmitter comprising:
a connection request information transmitting section for transmitting the connection request information at a predetermined period; and
a data transmission section for transmitting the data related to the connection request information after transmitting the connection request information.

10. The transmitter as set forth in claim 9, further comprising a completion information transmitting section for transmitting completion information indicative of completion of data that is transmitted from the transmitter in response to the connection request information.

11. The transmitter as set forth in claim 9, wherein:
the data to be transmitted to the receiver by the data transmission section is one or more packet data in which a certain amount of streaming data is stored, and
a different identification number is assigned to each of said one or more packet data.

12. The transmitter as set forth in claim 9, wherein:
when the transmitter transmits the data to the receiver, the receiver sends back, within a predetermined period of time, reception confirmation information indicating that the data transmitted by the transmitter has been received by the receiver, and
the data transmission section transmits data to be subsequently transmitted, when the transmitter has received the reception confirmation information or when the transmitter has received no reception confirmation information after elapse of a predetermined period of time from transmission of the data.

13. A communication system comprising:
a transmitter which transmits data; and
a receiver which establishes a communication, by a directional wireless communication, between the receiver and the transmitter, and which receives the data from the transmitter,
the transmitter transmitting connection request information for requesting a connection between the transmitter and the receiver to the receiver at a predetermined period, and the transmitter transmitting data related to the connection request information to the receiver after transmitting the connection request information,
said receiver including:
a communication device for establishing a communication between the transmitter and the receiver, and for releasing the communication thus established;
a release control section for carrying out a control with respect to the communication device to release the communication thus established between the transmitter and the receiver; and
an establishment control section which controls the communication device so that a connection between the transmitter and the receiver is established in accordance with the connection request information, in a case where the connection request information is received from the transmitter while the communication established between the transmitter and the receiver is released in accordance with the control with respect to the communication device which control is carried out by the release control section,
said transmitter including:
a connection request information transmitting section for transmitting connection request information for requesting a connection at a predetermined period; and
a data transmission section for transmitting the data related to the connection request information after transmitting the connection request information.

14. The communication system as set forth in claim 13, wherein the communication between the receiver and the transmitter is carried out by use of an IrSimple, which is an infrared communication protocol.

15. A method for controlling a receiver which establishes a communication, by a directional wireless communication, between the receiver and a transmitter that transmits data, and which receives the data from the transmitter,
the transmitter transmitting connection request information for requesting a connection between the transmitter and the receiver to the receiver at a predetermined period, and the transmitter transmitting data related to the connection request information to the receiver after transmitting the connection request information,
said method comprising the steps of:
(i) releasing a communication established between the transmitter and the receiver; and
(ii) causing a connection between the transmitter and the receiver to be established in accordance with the connection request information, in a case where the connection request information is received from the transmitter while the communication established between the transmitter and the receiver is released in accordance with the step (i).

16. A communication method for transmitting data from a transmitter to a receiver via a directional wireless communication, the communication method comprising the steps of:
transmitting connection request information, for requesting a connection between the transmitter and the receiver, from the transmitter to the receiver at a predetermined period;
transmitting the data related to the connection request information from the transmitter to the receiver after transmitting the connection request information; and
causing a connection between the transmitter and the receiver to be established in accordance with the connection request information so that the data transmitted from the transmitter is received, in a case where the connection request information is received from the transmitter while the communication between the transmitter and the receiver is released.

17. A computer-readable storage medium in which a program is stored for controlling a receiver,
said program causing a computer to function as respective sections of the receiver,
said receiver establishing a communication, by a directional wireless communication, between the receiver and a transmitter that transmits data, and which receives the data from the transmitter,
the transmitter transmitting connection request information for requesting a connection between the transmitter and the receiver to the receiver at a predetermined period, and the transmitter transmitting data related to the connection request information to the receiver after transmitting the connection request information,
said receiver comprising:
a communication device for establishing a communication between the transmitter and the receiver, and for releasing the communication thus established;
a release control section for carrying out a control with respect to the communication device to release the communication thus established between the transmitter and the receiver; and
an establishment control section which controls the communication device so that a connection between the transmitter and the receiver is established in accordance with the connection request information, in a case where the connection request information is received from the transmitter while the communication established between the transmitter and the receiver is released in accordance with the control with respect to the communication device which is carried out by the release control section.
